(19) United States
(12) Patent Application Publication
(10) Pub. No.: US 2023/0164847 A1
(43) Pub. Date: May 25, 2023

(54) METHOD AND APPARATUS FOR TRANSMITTING AND RECEIVING DATA AND CONTROL SIGNAL BY SATELLITE COMMUNICATION-CAPABLE TERMINAL IN WIRELESS COMMUNICATION SYSTEM

(71) Applicant: Samsung Electronics Co., Ltd., Suwon-si, Gyeonggi-do (KR)

(72) Inventors: Younsun KIM, Suwon-si (KR); Jeongho YEO, Suwon-si (KR); Hyoungju JI, Suwon-si (KR); Hyukchoon KWON, Suwon-si (KR)

(21) Appl. No.: 17/917,739

(22) PCT Filed: Apr. 12, 2021
(86) PCT No.: PCT/KR2021/004549

§ 371 Date: Oct. 7, 2022

(30) Foreign Application Priority Data
Apr. 10, 2020 (KR) 10-2020-0044281
May 6, 2020 (KR) 10-2020-0053825

(51) Int. Cl. H04W 74/08

(52) U.S. Cl. CPC H04W 74/0833; H04W 74/0866; H04W 84/06

(57) ABSTRACT

Disclosed are a communication technique which merges, with IoT technology, a 5G communication system for supporting a data transmission rate higher than that of a 4G system, and a system therefor. The present disclosure may be applied to intelligent services (for example, smart homes, smart buildings, smart cities, smart cars or connected cars, health care, digital education, retail, security and safety related services, etc.) on the basis of 5G communication technology and IoT-related technology. Disclosed are a method and apparatus in which a terminal performs satellite communication.

### TECHNICAL FIELD

The disclosure relates to a communication system, and provides a method and an apparatus in which, when a terminal is capable of supporting both terrestrial network communication and satellite communication, the terminal operates differently depending on whether signal transmission or reception is performed in a situation of terrestrial communication or in a situation of satellite communication.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a “beyond 4G network” communication system or a “post LTE” system. The 5G communication system is considered to be implemented in ultrahigh frequency (mmWave) bands (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are discussed in 5G communication systems. In addition, in 5G communication systems, development for system network improvement is under way based on advanced small cells, cloud radio access networks (cloud RANs), ultra-dense networks, device-to-device (D2D) communication, wireless backhaul, moving network, cooperative communication, coordinated multi-points (CoMP), reception-end interference cancellation and the like. In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology.

In the late 2010s and 2020s, as the cost of launching satellites is dramatically decreased, more companies have been trying to provide communication services through satellites. Accordingly, the satellite network has emerged as a next-generation network system for supplementing the existing terrestrial network. Although the satellite network does not provide a terrestrial network-level user experience, the satellite network can provide communication services in an area in which terrestrial networks are difficult to be built or in disaster situations. As described above, economic feasibility is secured through a recent sharp decrease in satellite launch costs. Some companies and 3GPP organizational partners are also promoting direct communication between smartphones and satellites.

### DISCLOSURE OF INVENTION

### Technical Problem

The disclosure proposes a method and apparatus for efficiently providing satellite network communication to a terminal.

### Solution to Problem

In order to solve the above problems, a method performed by a terminal in a communication system according to an embodiment of the disclosure includes: determining whether the terminal performs terrestrial network communication or satellite network communication; determining an antenna used for transmission or reception based on the determination; and performing communication using the antenna, wherein in case that the satellite network communication is determined to be performed, an antenna, which is included in the terminal and is close to a location of a satellite relating to the satellite network communication, is used to perform the communication.

In addition, a terminal in a communication system includes: a transceiver; and a controller configured to determine whether the terminal performs terrestrial network communication or satellite network communication, determine an antenna used for transmission or reception based on the determination, and control to perform communication using the antenna, wherein in case that the satellite network communication is determined to be performed, an antenna, which is included in the terminal and is close to a location of a satellite relating to the satellite network communication, is used to perform the communication.

### Advantageous Effects of Invention

According to the disclosure described above, a terminal can distinguish between terrestrial network communication and satellite communication, whereby efficient signal transmission or reception is possible.

### BRIEF DESCRIPTION OF DRAWINGS

FIG. 1 illustrates a basic structure of a time-frequency domain, which is a radio resource domain in which data or a control channel is transmitted in a downlink or uplink in an NR system;

FIG. 2 illustrates a control resource set in which a downlink control channel is transmitted in a 5G wireless communication system;

FIG. 3 illustrates an example in which data for eMBB, URLLC, and mMTC are allocated in the entire system frequency bandwidth;

FIG. 4 illustrates an example in which the system frequency bandwidth is divided and data for eMBB, URLLC, and mMTC are allocated;

FIG. 5 illustrates an example of a process in which one transport block is divided into multiple code blocks and CRCs are added thereto;

FIG. 6 illustrates an aspect in which a synchronization signal (SS) and a physical broadcast channel (PBCH) of an NR system are mapped in a frequency and a time domain;

FIG. 7 illustrates symbols to which an SS/PBCH block can be transmitted according to a subcarrier spacing;

FIG. 8 illustrates a UE processing time according to a timing advance when the UE receives a first signal and transmits a second signal thereto in a 5G or NR system according to a disclosed embodiment;

FIG. 9 illustrates an example of scheduling and transmitting pieces of data (e.g., TBs) according to a slot, receiving HARQ-ACK feedback for the corresponding data, and performing retransmission according to the feedback;

FIG. 10 illustrates an example of a communication system using a satellite;

FIG. 11 illustrates a period in which a communication satellite orbits the Earth according to an altitude or height of a satellite;

FIG. 12 illustrates a conceptual diagram of satellite-to-terminal direct communication;

FIG. 13 illustrates a utilization scenario of satellite-terminal direct communication;

FIG. 14 illustrates an example of calculating an expected data rate (throughput) in an uplink when an LEO satellite at the altitude of 1200 km and a terrestrial terminal perform direct communication;

FIG. 15 illustrates an example of calculating an expected data rate (throughput) in an uplink when a GEO satellite at the altitude of 35,786 km and a terrestrial terminal perform direct communication;

FIG. 16 illustrates a path loss value according to a path loss model between a terminal and a satellite, and a path loss according to a path loss model between a terminal and a terrestrial gNB;

FIG. 17 illustrates equations for calculation of the amount of Doppler shift experienced by a signal, which is transmitted from a satellite and received by a terrestrial user according to the altitude and position of the satellite and the position of a terminal user on the ground, and results thereof;

FIG. 18 illustrates the speed of a satellite calculated at the altitude of the satellite;

FIG. 19 illustrates Doppler shifts experienced by different terminals within one beam, which is transmitted by a satellite to the ground;

FIG. 20 shows the difference in Doppler shift occurring within one beam according to the position of a satellite determined from an elevation angle;

FIG. 21 illustrates a latency taken from a UE to a satellite and a round trip latency between a UE-a satellite-a base station according to the position of the satellite determined according to an elevation angle;

FIG. 22 illustrates the value of maximum difference in round-trip latencies that vary according to a user's position within one beam;

FIG. 23 illustrates an example in which one terminal may perform both a terrestrial network communication function and a satellite-terminal direct communication function;

FIG. 24 illustrates the structure and location of a transmission/reception antenna of a terminal;

FIG. 25 illustrates an example in which a user adjusts the direction of a terminal in a random manner;

FIG. 26 illustrates a method in which a terminal determines an antenna to be used for communication;

FIG. 27 is a block diagram illustrating an internal structure of a terminal according to an embodiment of the disclosure;

FIG. 28 is a block diagram illustrating an internal structure of a base station according to an embodiment of the disclosure; and

FIG. 29 is a block diagram illustrating an internal structure of a satellite according to an embodiment of the disclosure.

### MODE FOR THE INVENTION

New radio access technology (NR), which is new 5G communication, is designed to enable various services to be freely multiplexed in time and frequency resources. Accordingly, in the NR system, a waveform/numerology or the like, and/or a reference signal or the like may be dynamically or freely allocated according to needs of a corresponding service. In order to provide an optimal service to a terminal in wireless communication, it is required to perform data transmission optimized based on measurements of channel quality and interference. Accordingly, it is essential to accurately measure a channel state. The channel and interference characteristics are not dramatically changed depending on a frequency resource in a 4G communication system. However, unlike the 4G communication system, the channel and interference characteristics of which are not dramatically changed depending on a frequency resource, the channel and interference characteristics are dramatically changed depending on a service in a case of a 5G channel. Accordingly, subset support in a frequency resource group (FRG) dimension may be required in order to separately measure channel and interference characteristics. Meanwhile, the types of services supported in the NR system may be categorized into enhanced mobile broadband (eMBB), massive machine type communications (mMTC), and ultra-reliable and low-latency communications (URLLC). The eMBB may be a service targeting high-speed transmission of high-capacity data. The mMTC may be a service that targets minimizing power consumption by a terminal and access of multiple terminals. URLLC may be a service targeting high-reliability and low-latency. Different requirements may be applied depending on the type of service applied to a terminal.

As described above, a plurality of services may be provided to a user in a communication system, and in order to provide the plurality of services to a user, there is a desire for a method and apparatus for providing respective services in the same time interval according to the characteristics of the communication system.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services. Further, 5G or new radio (NR) communication standards as 5th-generation wireless communication systems are under discussion.

As a typical example of the broadband wireless communication system, an NR system employs an orthogonal frequency division multiplexing (OFDM) scheme in a downlink (DL) and an uplink (UL). In the disclosure, the downlink refers to a radio link via which a base station transmits a signal to a terminal, and the uplink refers to a radio link via which a terminal transmits a signal to a base station. More specifically, a cyclic-prefix OFDM (CP-OFDM) scheme is employed in the downlink, and two schemes, that is, CP-OFDM and discrete Fourier transform spreading OFDM (DFT-S-OFDM) scheme, are employed in the uplink. The uplink indicates a radio link through which a user equipment (UE) {or a mobile station (MS)} transmits data or control signals to a base station (or gNode B), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

The NR system employs a hybrid automatic repeat request (HARQ) scheme that retransmits corresponding data in a physical layer if decoding fails at the initial transmission. In the HARQ scheme, if a receiver fails to accurately decode data, the receiver transmits, to a transmitter, information (negative acknowledgement (NACK)) notifying of a decoding failure, so as to allow the transmitter to retransmit the corresponding data in a physical layer. The receiver combines data retransmitted by the transmitter with the previous data, for which decoding has failed, to increase a data reception performance. In addition, if the receiver accurately decodes data, the receiver transmits, to the transmitter, information (acknowledgement (ACK)) notifying of a decoding success, so as to allow the transmitter to transmit new data.

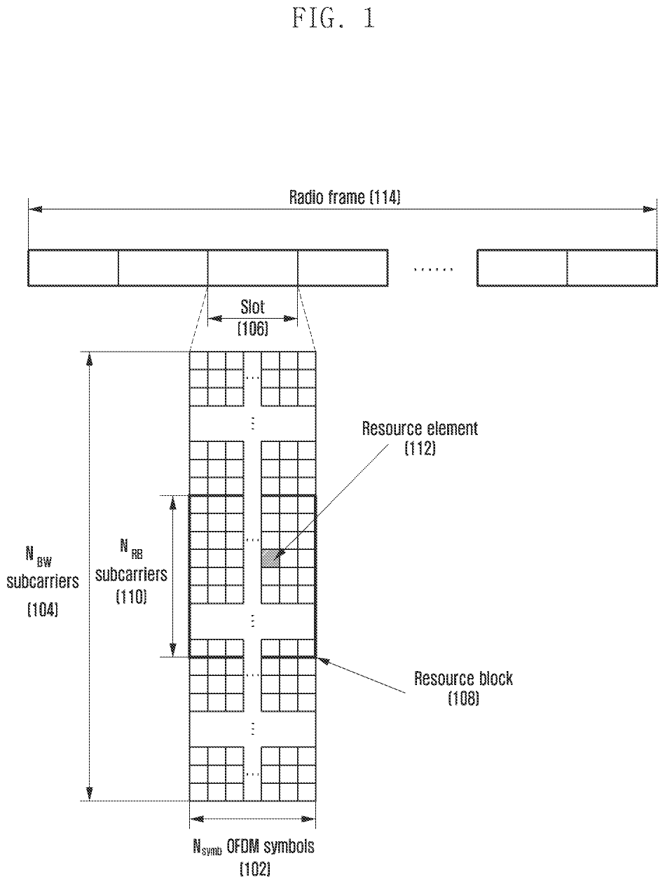

FIG. 1 illustrates a basic structure of a time-frequency domain, which is a radio resource region in which data or a control channel is transmitted through a downlink or uplink in an NR system.

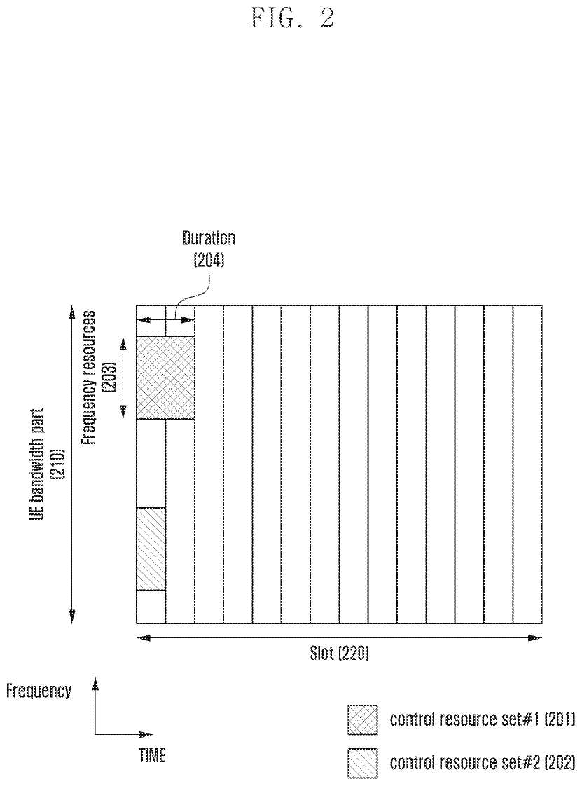

Referring to FIG. 1, the horizontal axis indicates the time domain, and the vertical axis indicates the frequency domain. The minimum transmission unit in the time domain is an OFDM symbol, and N_{symb} OFDM symbols 102 are gathered to configure one slot 106. The length of a subframe is defined as 1.0 ms, and a radio frame 114 is defined as 10 ms. The minimum transmission unit in the frequency domain is a subcarrier, and the bandwidth of the entire system transmission band is configured by a total of N_{BW} subcarriers 104. 1 frame may be defined as 10 ms. 1 subframe may be defined as 1 ms, and thus 1 frame may be configured by a total of 10 subframes. 1 slot may be defined as 14 OFDM symbols (i.e., the number of symbols for 1 slot (N_{symb}^{slot}=14)). 1 subframe may include one or multiple slots, and the number of slots per 1 subframe may differ according to configuration value μ for a subcarrier spacing. In the example of FIG. 2, a case in which the subcarrier spacing configuration value is μ=0 and a case in which the subcarrier spacing configuration value is μ=1 are illustrated. If μ=0, 1 subframe may include one slot, and if μ=1, 1 subframe may include two slots. That is, the number of slots per 1 subframe (Nₛₗₒₜ^{subframe, μ}) may differ according to a subcarrier spacing configuration value μ, and accordingly, the number of slots per 1 frame (Nₛₗₒₜ^{frame,μ}) may differ. According to each subcarrier spacing configuration μ, Nₛₗₒₜ^{subframe, μ} and Nₛₗₒₜ^{frame,μ} may be defined in Table 1 below.

TABLE 1

| μ | N_{symb}^{slot} | Nₛₗₒₜ^{frame, μ} | Nₛₗₒₜ ^{subframe, μ} |
|---|---|---|---|
| 0 | 14 | 10 | 1 |
| 1 | 14 | 20 | 2 |
| 2 | 14 | 40 | 4 |
| 3 | 14 | 80− | 8 |
| 4 | 14 | 160 | 16 |

A UE before radio resource control (RRC) connection may be configured with an initial bandwidth part (BWP) for initial access from a base station through a master information block (MIB). More specifically, the UE may receive configuration information about a search space and a control resource set (CORESET), in which a physical downlink control channel (PDCCH) for reception of system information required for initial access (which may correspond to remaining system information (RMSI) or system information block 1 (SIB 1)) may be transmitted, through the MIB in an initial access operation. The control resource set (CORESET) and search space, which are configured through the MIB, may be regarded as identity (ID) 0. The base station may notify the UE of configuration information, such as frequency allocation information, time allocation information, and numerology for the control resource set #0 through the MIB. In addition, the base station may notify the UE of configuration information regarding the monitoring periodicity and occasion for the control resource set #0, that is, configuration information regarding the search space #0, through the MIB. The UE may regard the frequency domain configured as the control resource set #0, obtained from the MIB, as an initial BWP for initial access. Here, the identifier (ID) of the initial BWP may be regarded as zero.

The MIB may include the following pieces of information.

```
  -- ASN1START
  -- TAG-MIB-START
  MIB ::=  SEQUENCE {
    systemFrameNumber BIT STRING (SIZE (6)),
    subCarrierSpacingCommon ENUMERATED {scs15or60,
scs30or120},
    ssb-SubcarrierOffset  INTEGER (0..15),
    dmrs-TypeA-Position  ENUMERATED {pos2, pos3},
    pdcch-ConfigSIB1 PDCCH-ConfigSIB1,
    cellBarred  ENUMERATED {barred, notBarred},
    intraFreqReselection  ENUMERATED {allowed, notAllowed),
    spare BIT STRING (SIZE(1))
  }
  -- TAG-MIB-STOP
  -- ASN1STOP
```

MIB Field Descriptions

cellBarred

Value barred means that the cell is barred, as defined in TS 38.304 [20].

dmrs-TypeA-Position

Position of (first) DM-RS for downlink (see TS 38.211 [16], clause 7.4.1.1.2) and uplink (see TS 38.211 [16], clause 6.4.1.1.3).

intraFreqReselection

Controls cell selection/reselection to intra-frequency cells when the highest ranked cell is barred, or treated as barred by the UE, as specified in TS 38.304 [20].

pdcch-ConfigSIB1

Determines a common ControlResourceSet (CORESET), a common search space and necessary PDCCH parameters. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1 (see TS 38.213 [13], clause 13).

ssb-SubcarrierOffset

Corresponds to kSSB (see TS 38.213 [13]), which is the frequency domain offset between SSB and the overall resource block grid in number of subcarriers. (See TS 38.211 [16], clause 7.4.3.1).

The value range of this field may be extended by an additional most significant bit encoded within PBCH as specified in TS 38.213 [13].

This field may indicate that this cell does not provide SIB1 and that there is hence no CORESET #0 configured in MIB (see TS 38.213 [13], clause 13). In this case, the field pdcch-ConfigSIB1 may indicate the frequency positions where the UE may (not) find a SS/PBCH with a control resource set and search space for SIB1 (see TS 38.213 [13], clause 13).

subCarrierSpacingCommon

Subcarrier spacing for SIB1, Msg.2/4 for initial access, paging and broadcast SI-messages. If the UE acquires this MIB on an FR1 carrier frequency, the value scs15or60 corresponds to 15 kHz and the value scs30or120 corresponds to 30 kHz. If the UE acquires this MIB on an FR2 carrier frequency, the value scs15or60 corresponds to 60 kHz and the value scs30or120 corresponds to 120 kHz.

systemFrameNumber

The 6 most significant bits (MSB) of the 10-bit System Frame Number (SFN). The 4 LSB of the SFN are conveyed in the PBCH transport block as part of channel coding (i.e. outside the MIB encoding), as defined in clause 7.1 in TS 38.212 [17].

In a method of configuring the bandwidth part, the UEs before the RRC connection may receive configuration information about the initial bandwidth part through the master information block (MIB) in the initial access operation. More specifically, the UE may be configured with a control resource set for a downlink control channel through which downlink control information (DCI) for scheduling a SIB may be transmitted from a MIB of a physical broadcast channel (PBCH). The bandwidth of the control resource set configured through the MIB may be regarded as the initial bandwidth part. The UE may receive, through the configured initial bandwidth part, a physical downlink shared channel (PDSCH) through which the SIB is transmitted. The initial bandwidth part may be used for other system information (OSI), paging, and random access as well as the reception of the SIB.

When one or more bandwidth parts have been configured for a UE, a base station may indicate the UE to change the bandwidth part by using a bandwidth part indicator field in DCI.

In the NR system, in a case of a FDD system in which downlink and uplink are operated at separate frequencies, the downlink transmission bandwidth and the uplink transmission bandwidth may be different from each other. The channel bandwidth indicates an RF bandwidth corresponding to the system transmission bandwidth. Table 2 and Table 3 show part of a correspondence among a system transmission bandwidth, a subcarrier spacing, and a channel bandwidth defined in the NR system at a frequency bandwidth below 6 GHz and at a frequency bandwidth above 6 GHz, respectively. For example, in an NR system having a 100 MHz channel bandwidth at a 30 KHz subcarrier spacing, the transmission bandwidth is configured by 273 RBs. In the following, N/A may be a combination of a bandwidth and a subcarrier, which is not supported by the NR system.

TABLE 2

| | 5 | 10 | 15 | 20 | 25 | 30 | 40 | 50 | 60 | 80 | 90 | 100 |
|---|---|---|---|---|---|---|---|---|---|---|---|---|
| SCS | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

TABLE 3

| | Channel Bandwidth BW_{channel} (MHz) | | | | |
|---|---|---|---|---|---|
| | Subcarrier | | | | |
| | spacing | 50 MHz | 100 MHz | 200 MHz | 400 MHz |
| Transmission | 60 kHz | 66 | 132 | 264 | N/A |
| bandwidth | 120 kHz | 32 | 66 | 132 | 264 |
| configuration | | | | | |
| N_{RB} | | | | | |

In the NR system, the frequency range may be divided and defined as FR1 and FR2 as shown in Table 4.

TABLE 4

| Frequency range | Corresponding |
|---|---|
| designation | frequency range |
| FR1 | 450-7125 MHz |
| FR2 | 24250-52600 MHz |

In the above, the ranges of FR1 and FR2 may be differently changed and applied. For example, the frequency range of FR1 may be changed from 450 MHz to 6000 MHz and applied.

Next, a synchronization signal (SS)/physical broadcast channel block (PBCH) block in 5G will be described.

The SS/PBCH block may refer to a physical layer channel block including a primary SS (PSS), a secondary SS (SSS), and a PBCH. Specifically, the SS/PBCH block is as follows:
PSS: a signal serves as a reference for downlink time/frequency synchronization and provides some information of a cell ID.
SSS: a signal serves as a reference for downlink time/frequency synchronization, and provides the remaining cell ID information that is not provided by the PSS. In addition, the SSS may serve as a reference signal for demodulation of the PBCH.
PBCH: the PBCH provides essential system information required for transmission or reception of a data channel and a control channel of a UE. The essential system information may include search space related control information indicating radio resource mapping information of a control channel, scheduling control information for a separate data channel for transmission of system information, and the like.
SS/PBCH block: the SS/PBCH block includes a combination of a PSS, an SSS, and a PBCH. One or multiple SS/PBCH blocks may be transmitted within 5 ms, and each of the transmitted SS/PBCH blocks may be distinguished by indices.

The UE may detect the PSS and the SSS in the initial access operation, and may decode the PBCH. The UE may obtain the MIB from the PBCH, and may be configured with the control resource set #0 (which may correspond to the control resource set having the CORESET index of 0) therefrom. The UE may monitor the control resource set #0 under an assumption that a demodulation reference signal (DMRS) transmitted in the selected SS/PBCH block and the control resource set #0 is quasi-co-located (QCLed). The UE may receive system information based on downlink control information transmitted from the control resource set #0. The UE may obtain, from the received system information, configuration information related to a random access channel (RACH) required for initial access. The UE may transmit a physical RACH (PRACH) to the base station by considering the selected SS/PBCH index, and the base station having received the PRACH may obtain information about an SS/PBCH block index selected by the UE. Through this process, the base station may know which block has been selected among the SS/PBCH blocks by the UE, and may know that the control resource set #0 associated therewith is monitored.

Next, downlink control information (DCI) in a 5G system will be described in detail.

In the 5G system, scheduling information about uplink data (or physical uplink shared channel (PUSCH) or downlink data (or physical downlink shared channel (PDSCH)) is transmitted from a base station to a UE through the DCI. The UE may monitor a fallback DCI format and a non-fallback DCI format with regard to the PUSCH or the PDSCH. The fallback DCI format may include a fixed field predefined between the base station and the UE, and the non-fallback DCI format may include a configurable field. In addition, there are various formats of DCI, and the DCI may indicate, according to each format, whether it is DCI for power control, DCI for notifying of a slot format indicator (SFI), and the like.

The DCI may be transmitted through a PDCCH which is a physical downlink control channel after channel coding and modulation is performed thereon. A cyclic redundancy check (CRC) may be attached to a DCI message payload, and the CRC may be scrambled by a radio network temporary identifier (RNTI) corresponding to the identity of the UE. Different RNTIs may be used according to the purpose of the DCI message, for example, a UE-specific data transmission, a power adjustment command, or a random access response. That is, the RNTI is not explicitly transmitted, but is included in a CRC calculation process and then transmitted. When receiving the DCI message transmitted through the PDCCH, the UE may check a CRC by using an assigned RNTI. When a CRC check result is correct, the UE may know that the corresponding message has been transmitted to the UE. The PDCCH is mapped and transmitted in a control resource set configured for the UE.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling UE-specific PDSCH or PUSCH may be scrambled by a cell RNTI (C-RNTI).

DCI format 0_0 may be used as a fallback DCI for scheduling a PUSCH. Here, a CRC may be scrambled by a C-RNTI. The DCI format 0_0 in which the CRC is scrambled by the C-RNTI may include, for example, pieces of information below.

TABLE 5
- Identifier for DCI formats - [1] bit
- Frequency domain resource assignment -[┌log₂(N_{RB}^{UL,BWP}
(N_{RB}^{UL,BWP} + 1)/2)┐] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2] bits
- Uplink/supplementary UL (UL/SUL) indicator - 0 or 1 bit

DCI format 0_1 may be used as a non-fallback DCI for scheduling a PUSCH. Here, a CRC may be scrambled by a C-RNTI. The DCI format 0_1 in which the CRC is scrambled by the C-RNTI may include, for example, pieces of information below.

TABLE 6
-Carrier indicator - 0 or 3 bits
-UL/SUL indicator - 0 or 1 bit
-Identifier for DCI formats - [1] bits
-Bandwidth part indicator - 0, 1 or 2 bits
-Frequency domain resource assignment
•For resource allocation type 0, ┌N_{RB}^{UL,BWP} /P ┐ bits
•For resource allocation type 1, ┌log₂ (N_{RB}^{UL,BWP} (N_{RB}^{UL,BWP} +1) / 2)┐ bits
-Time domain resource assignment −1, 2, 3, or 4 bits
-VRB-to-PRB mapping (virtual resource block-to-physical resource block mapping) - 0 or
1 bit, only for resource allocation type 1.
•0 bit if only resource allocation type 0 is configured;
•1 bit otherwise.
-Frequency hopping flag - 0 or 1 bit, only for resource allocation type 1.
•0 bit if only resource allocation type 0 is configured.
•1 bit otherwise.
-Modulation and coding scheme - 5 bits
-New data indicator - 1 bit
-Redundancy version - 2 bits
-HARQ process number - 4 bits
-1st downlink assignment index -1 or 2 bits
•1 bit for semi-static HARQ-ACK codebook;
•2 bits for dynamic HARQ-ACK codebook with single HARQ-ACK codebook.
-2nd downlink assignment index - 0 or 2 bits
•2 bits for dynamic HARQ-ACK codebook with two HARQ-ACK sub-codebooks;
•0 bit otherwise.
-TPC command for scheduled PUSCH - 2 bits
-SRS resource indicator - $⌈ {log}_{2} ( \text{?} {\sum }_{k = 1} ( \begin{matrix}{N}_{SRS} \\ k\end{matrix} ) ) ⌉$ or ┌log₂ (N_{SRS})┐bits
• $⌈ {log}_{2} ( \text{?} {\sum }_{k = 1} ( \begin{matrix}{N}_{SRS} \\ k\end{matrix} ) ) ⌉$ bits for non-codebook based PUSCH transmission;
•┌log₂ (N_{SRS})┐ bits for codebook based PUSCH transmission.
-Precoding information and number of layers -up to 6 bits
-Antenna ports - up to 5 bits
-SRS request - 2 bits
-CSI request - 0, 1, 2, 3, 4, 5, or 6 bits
-Code block group (CBG) transmission information - 0, 2, 4, 6, or 8 bits
-PTRS-DMRS association (Phase tracking reference signal-demodulation reference signal
association)- 0 or 2 bits.
-beta_offset indicator - 0 or 2 bits
-Demodulation reference signal (DMRS) sequence initialization - 0 or 1 bit
$\text{?} \text{indicates text missing or illegible when filed}$

DCI format 1_0 may be used as a fallback DCI for scheduling a PDSCH. Here, a CRC may be scrambled by a C-RNTI. The DCI format 1_0 in which the CRC is scrambled by the C-RNTI may include, for example, the following pieces of information below.

TABLE 7
- Identifier for DCI formats - [1] bit
- Frequency domain resource assignment - [┌log₂(N_{RB}^{DL,BWP} (N_{RB}^{DL,BWP} +
1)/2)┐] bits
- Time domain resource assignment - X bits
- VRB-to-PRB mapping -1 bit.
- Modulation and coding scheme - 5 bits
- New data indicator -1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator - 3 bits
- PDSCH-to-HARQ feedback timing indicator - [3] bits

DCI format 1_1 may be used as a non-fallback DCI for scheduling a PDSCH. Here, a CRC may be scrambled by a C-RNTI. The DCI format 1_1 in which the CRC is scrambled by the C-RNTI may include, for example, pieces of information below.

TABLE 8
- Carrier indicator - 0 or 3 bits
- Identifier for DCI formats - [1] bits
- Bandwidth part indicator - 0, 1 or 2 bits
- Frequency domain resource assignment
• For resource allocation type 0, ┌N_{RB}^{DL,BWP} / P┐ bits
• For resource allocation type 1, ┌log₂(N_{RB}^{DL,BWP} (N_{RB}^{DL,BWP} + 1)/2)┐ bits
- Time domain resource assignment -1, 2, 3, or 4 bits
- VRB-to-PRB mapping - 0 or 1 bit, only for resource allocation type 1.
• 0 bit if only resource allocation type 0 is configured;
• 1 bit otherwise.
- Physical resource block (PRB) bundling size indicator - 0 or 1 bit
- Rate matching indicator - 0, 1, or 2 bits
- ZP CSI-RS trigger (Zero power channel state information reference signal trigger) - 0, 1, or
2 bits
For transport block 1:
- Modulation and coding scheme - 5 bits
- New data indicator -1 bit
- Redundancy version - 2 bits
For transport block 2:
- Modulation and coding scheme - 5 bits
- New data indicator -1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- Code block group (CBG) flushing out information - 0 or 1 bit
- DMRS sequence initialization - 1 bit

Each piece of control information included in the DCI format 1_1 may be as follows.
Carrier indicator: indicates a carrier via which data scheduled by DCI is transmitted—0 or 3 bits
Identifier for DCI formats: indicates a DCI format, and specifically, is an indicator for distinguishing whether the corresponding DCI is for downlink or uplink—[1] bits
Bandwidth part indicator: indicates if there is a change in the bandwidth part—0, 1 or 2 bits
Frequency domain resource assignment: is resource allocation information indicating frequency domain resource assignment, and a resource to be expressed differs according to whether the resource assignment type is “0” or “1”.
Time domain resource assignment: is resource assignment information indicating time domain resource assignment, and may indicate higher layer signaling or one configuration of a predetermined PDSCH time domain resource assignment list—1, 2, 3, or 4 bits
VRB-to-PRB mapping: indicates a mapping relationship between a virtual resource block (VRB) and a physical resource block (PRB)—0 or 1 bit
PRB bundling size indicator: indicates the bundling size of a physical resource block to which the same precoding is assumed to be applied—0 or 1 bit
Rate matching indicator: indicates a rate match group to be applied, among rate match groups configured as a higher layer applied to the PDSCH—0, 1, or 2 bits
ZP CSI-RS trigger: triggers a zero power channel state information reference signal—0, 1, or 2 bits
Transport block (TB)-related configuration information: indicates a modulation and coding scheme (MCS), a new data indicator (NDI), and a redundancy version (RV) for one or two TBs.
Modulation and coding scheme (MCS): indicates a modulation scheme and a coding rate used for data transmission. That is, MCS may indicate a coding rate value capable of notifying of TBS and channel coding information together with information on whether it is QPSK, 16QAM, 64QAM, or 256QAM.
New data indicator: indicates whether HARQ transmission is initial transmission or retransmission.
Redundancy version: indicates the redundancy version of HARQ.
HARQ process number: indicates HARQ process number applied to PDSCH; 4 bits
Downlink assignment index: An index for generating a dynamic HARQ-ACK codebook at the time of reporting HARQ-ACK for PDSCH—0 or 2 or 4 bits
TPC command for scheduled PUCCH: power control information applied to PUCCH for HARQ-ACK reporting on PDSCH—2 bits
PUCCH resource indicator: Information indicating a resource of a PUCCH for HARQ-ACK reporting on a PDSCH—3 bits
PDSCH-to-HARQ_feedback timing indicator: Configuration information of a slot through which PUCCH for HARQ-ACK reporting on PDSCH is transmitted—3 bits
Antenna ports: Information indicating an antenna port of PDSCH DMRS and DMRS CDM group in which PDSCH is not transmitted—4, 5 or 6 bits
Transmission configuration indication: Information indicating beam related information of PDSCH—0 or 3 bits
SRS request: Information for requesting SRS transmission—2 bits
CBG transmission information: If code block group-based retransmission is configured, information indicating data, which belongs to a code block group (CBG), is transmitted through PDSCH—0, 2, 4, 6, or 8 bits
CBG flushing out information: Information indicating whether a code block group previously received by a terminal can be used for HARQ combining—0 or 1 bit
DMRS sequence initialization: indicates DMRS sequence initialization parameters—1 bit

Hereinafter, a method of allocating time domain resources for a data channel in a 5G communication system will be described.

A base station may configure, for a UE, a table for time-domain resource allocation information for a downlink data channel (PDSCH) and an uplink data channel (PUSCH) via higher layer signaling (e.g., RRC signaling). For PDSCH, a table including maxNrofDL-Allocations=16 entries at most may be configured, and for PUSCH, a table including maxNrofUL-Allocations=16 entries at most may be configured. The time-domain resource allocation information may include PDCCH-to-PDSCH slot timing (corresponding to a time interval in slot units between a timing at which a PDCCH is received and a timing at which a PDSCH scheduled by the received PDCCH is transmitted, and denoted by K0), PDCCH-to-PUSCH slot timing (corresponding to a time interval in slot units between a timing at which a PDCCH is received and a timing at which a PUSCH scheduled by the received PDCCH is transmitted, and denoted by K2), information on the position and length of a start symbol in which the PDSCH or PUSCH is scheduled within a slot, a mapping type of PDSCH or PUSCH, and the like. For example, information such as Table 9 or Table 10 below may be transmitted from the base station to the UE.

TABLE 9
PDSCH-TimeDomainResourceAllocationList information element
PDSCH-TimeDomainResourceAllocationList ::= SEQUENCE
(SIZE(1..maxNrofDL-Allocations)) OF PDSCH-
TimeDomainResourceAllocation
PDSCH-TimeDomainResource Allocation ::= SEQUENCE {
k0 INTEGER(0..32) OPTIONAL,
-- Need S
(PDCCH-to-PDSCH timing, slot units)
mappingType ENUMERATED {typeA, typeB},
(PDSCH mapping type)
startSymbolAndLength INTEGER (0..127)
(Start symbol and length of PDSCH)
}

TABLE 10

PUSCH-TimeDomainResourceAllocation information element
PUSCH-TimeDomainResourceAllocationList ::= SEQUENCE
(SIZE(1..maxNrofUL-Allocations)) OF PUSCH-
TimeDomainResourceAllocation
PUSCH-TimeDomainResource Allocation ::= SEQUENCE {
k2 INTEGER(0..32) OPTIONAL, -- NeedS
(PDCCH-to-PUSCH timing, slot units)
mappingType ENUMERATED {typeA, typeB},
(PUSCH mapping type)
startSymbolAndLength INTEGER (0..127)
(Start symbol and length of PUSCH)
}

The base station may notify one of the entries in the above-described table representing the time-domain resource allocation information to the UE via L 1 signaling (e.g., DCI) (e.g., may be indicated by a “time-domain resource allocation” field in DCI). The UE may acquire time-domain resource allocation information for the PDSCH or PUSCH based on the DCI received from the base station.

In a case of data transmission through PDSCH or PUSCH, time-domain resource assignment may be transferred based on information about a slot in which a PDSCH or PUSCH is transmitted, a start symbol position S in the corresponding slot, and the number L of symbols to which the PDSCH or PUSCH is mapped. In the above, S may be a relative position from the start of a slot, L may be the number of consecutive symbols, and S and L may be determined based on a start and length indicator value (SLIV) defined as follows.

if (L−1)≤7 then SLIV=14·(L−1)+S

else SLIV=14·(14−L−1)+(14−1−S) Equation 1

In the NR system, a terminal may receive, through RRC configuration, the configuration in which an SLIV value, a PDSCH/PUSCH mapping type, and information on a slot in which a PDSCH/PUSCH is transmitted are included in one row (for example, the information may be configured in the form of Table). Thereafter, for the time-domain resource assignment of the DCI, by indicating an index value in the table configured as above, a base station may transmit, to a terminal, the SLIV value, the PDSCH or PUSCH mapping type, and information on the slot in which the PDSCH or PUSCH is transmitted.

In the NR system, the PUSCH mapping type is defined by type A and type B. With regard to the PUSCH mapping type A, the first symbol among DMRS symbols is located at the second or the third OFDM symbol in a slot. With regard to the PUSCH mapping type B, the first symbol among DMRS symbols is located at the first OFDM symbol in a time domain resource assigned via PUSCH transmission.

Hereinafter, a downlink control channel in a 5G communication system will be described in more detail with reference to the drawings.

FIG. 2 illustrates an example of a control resource set in which a downlink control channel is transmitted in a 5G wireless communication system. FIG. 2 illustrates an example in which a UE bandwidth part 210 is configured in a frequency domain and two control resource sets (control resource set #1 201 and control resource set #2 202) are configured in 1 slot 220 in a time domain. The control resource sets 201 and 202 may be configured in a specific frequency resource 203 within the entire UE BWP 210 in the frequency domain. The control resource set may be configured with one or multiple OFDM symbols in the time domain, and this may be defined as a control resource set duration 204. Referring to an example illustrated in FIG. 2, the control resource set #1 201 is configured with the control resource set duration of two symbols, and the control resource set #2 202 is configured with the control resource set duration of one symbol.

The control resource set in the 5G system above may be configured for the UE by the base station via higher layer signaling (e.g., system information, MIB, RRC signaling). Configuration of the control resource set for the UE may be understood as providing information such as a control resource set identity, a frequency location of the control resource set, a symbol length of the control resource set, and the like. The higher layer signaling may include, for example, pieces of information of Table 11 below.

TABLE 11
ControlResourceSet ::= SEQUENCE {
Corresponds to L1 parameter 'CORESET-ID'
controlResourceSetId ControlResourceSetId,
(Control resource set Identity)
frequencyDomainResources BIT STRING (SIZE (45)),
(Frequency domain resource allocation information)
duration INTEGER (1..maxCoReSetDuration),
(Time domain resource allocation information)
cce-REG-MappingType CHOICE {
(CCE-to-REG mapping scheme)
interleaved SEQUENCE {
reg-Bundle Size ENUMERATED {n2, n3, n6},
(REG bundle size)
precoderGranularity ENUMERATED {sameAsREG-
bundle, allContiguousRBs},
interleaverSize ENUMERATED {n2, n3, n6}
(Interleaver size)
shiftIndex
INTEGER(0..maxNrofPhysicalResourceBlocks-1)
OPTIONAL
(Interleaver shift (Shift))
},
nonInterleaved NULL
},
tci-StatesPDCCH SEQUENCE(SIZE (1..
maxNrofTCI-StatesPDCCH)) OF TCI-StateId OPTIONAL,
(QCL configuration information)
tci-PresentInDCI ENUMERATED {enabled}
OPTIONAL, -- Need S
}

In Table 11, tci-StatesPDCCH (simply referred to as transmission configuration indication (TCI) state) configuration information may include information about one or multiple SS/PBCH block indices having a quasi-co-located (QCLed) relationship with a DMRS transmitted in the corresponding control resource set or a channel state information reference signal (CSI-RS) index.

The downlink data may be transmitted through a physical downlink shared channel (PDSCH) serving as a physical channel for downlink data transmission. The PDSCH may be transmitted after a control channel transmission interval, and scheduling information, such as a specific mapping position and modulation scheme in the frequency domain may be determined based on DCI transmitted through the PDCCH.

Through an MCS among control information configuring the DCI, a base station may notify a terminal of a modulation scheme applied to a PDSCH to be transmitted and the size (transport block size (TBS)) of data to be transmitted. In an embodiment, the MCS may be configured by 5 bits or more or fewer bits. The TBS corresponds to the size of data (transport block, TB) that the base station desires to transmit, before application of the channel coding for error correction to the data.

In the disclosure, a transport block (TB) may include a medium access control (MAC) header, a MAC control element (CE), one or more MAC service data units (SDUs), and padding bits. Alternatively, the TB may indicate the unit of data, which is delivered from a MAC layer to a physical layer, or a MAC protocol data unit (MAC PDU).

The modulation schemes supported by the NR system are quadrature phase shift keying (QPSK), 16 quadrature amplitude modulation (16 QAM), 64 QAM, and 256 QAM. Modulation orders (Qm) of the QPSK, 16 QAM, 64 QAM, and 256 QAM correspond to 2, 4, 6, and 8, respectively. That is, 2 bits per symbol in a case of QPSK modulation, 4 bits per symbol in a case of 16 QAM modulation, 6 bits per symbol in a case of 64 QAM modulation, and 8 bits per symbol in a case of 256 QAM modulation may be transmitted.

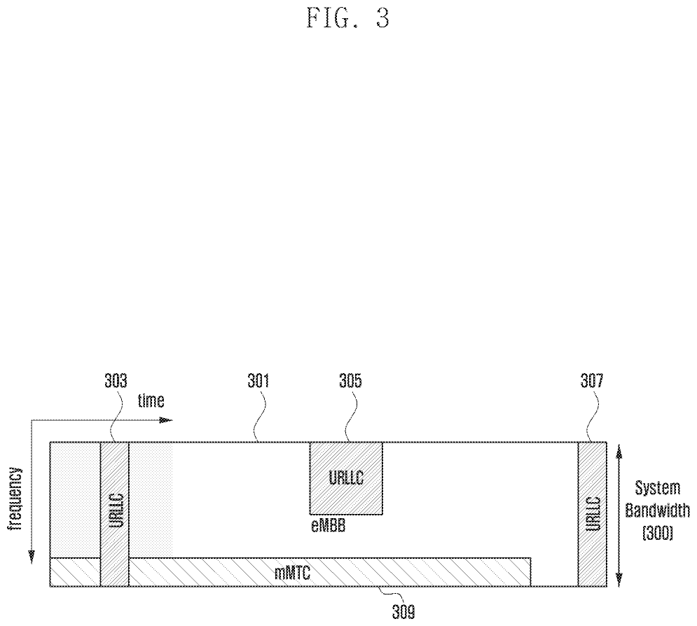

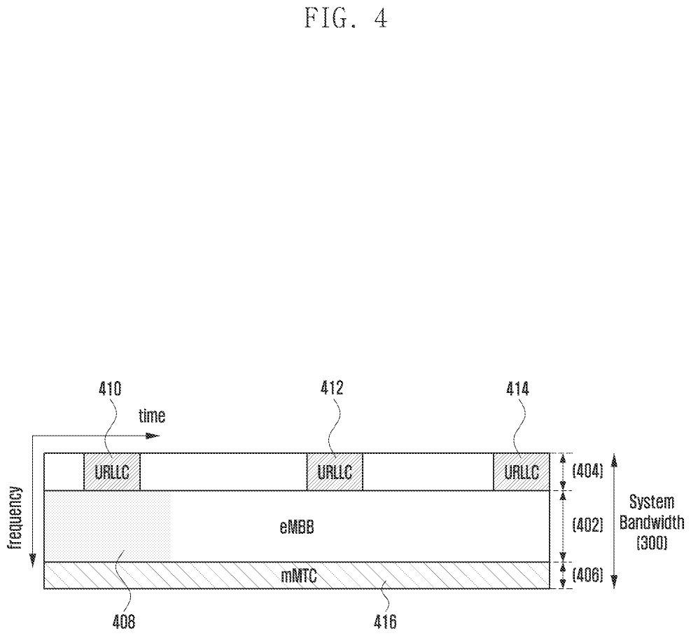

FIGS. 3 and 4 illustrate an example in which data for eMBB, URLLC, and mMTC, which are services considered in the 5G or NR system, are allocated in frequency-time resources.

Referring to FIGS. 3 and 4, there may be presented a scheme in which frequency and time resources are allocated for performing information transmission in each system.

FIG. 3 illustrates an embodiment in which data for eMBB, URLLC, and mMTC are allocated in the entire system frequency bandwidth. FIG. 3 illustrates an aspect in which data for eMBB, URLLC, and mMTC are allocated in the entire system frequency bandwidth 300. In the middle of allocation and transmission of eMBB 301 and mMTC 309 in a specific frequency bandwidth, if URLLC data 303, 305, and 307 occur and transmission thereof is thus necessary, the URLLC data 303, 305, and 307 may be transmitted without emptying or transmitting a portion in which the eMBB 301 and the mMTC 309 have been already allocated. Since the URLLC needs to reduce a latency in the middle of service, URLLC data 303, 305, and 307 may be allocated to a portion of the resource to which the eMBB 301 is allocated, and thus may be transmitted. Of course, in a case where URLLCs are additionally allocated and transmitted in a resource to which the eMBB is allocated, the eMBB data may not be transmitted in an overlapping frequency-time resource, and thus the transmission performance of the eMBB data may be lowered. That is, in the above case, eMBB data transmission failure due to URLLC allocation may occur.

FIG. 4 illustrate an example in which the system frequency bandwidth is divided and data for eMBB, URLLC, and mMTC are allocated. In FIG. 4, the entire system frequency bandwidth 400 may be divided into sub-bands 402, 404, and 406 and used for service and data transmission therein. Information associated with the sub-band configuration may be predetermined, and the information may be transmitted to a terminal by a base station via higher layer signaling. Alternatively, the information associated with the sub-bands may be divided by a base station or a network node in a predetermined manner and provide services to the terminal without transmitting separate sub-band configuration information. FIG. 4 illustrates that the sub-band 402 is used for transmission of eMBB data, the sub-band 404 is used for transmission of URLLC data, and the sub-band 406 is used for transmission of mMTC data.

In order to explain a method and apparatus proposed in the embodiment, the terms “physical channel” and “signal” in the NR system may be used. However, details of the disclosure may be applied to a wireless communication system other than the NR system.

Hereinafter, an embodiment of the disclosure will be described in detail with reference to the accompanying drawings. In the following description of the disclosure, a detailed description of known functions or configurations incorporated herein will be omitted when the same may make the subject matter of the disclosure rather unclear. The terms that will be used below are terms defined in consideration of the functions in the disclosure, and may differ according to users, intentions of the users, or customs. Therefore, the definitions of the terms should be made based on the contents throughout the specification.

Hereinafter, an embodiment of the disclosure is described using an NR system as an example, but an embodiment may be applied to other communication systems having a similar technical background or a similar channel form. In addition, embodiments of the disclosure may be modified without departing from the scope of the disclosure, and may be applied to other communication systems based on a determination by those skilled in the art.

In the disclosure, the terms “physical channel” and “signal” in a prior art may be used interchangeably with “data” or “control signal”. For example, a PDSCH is a physical channel through which data is transmitted, but in the disclosure, the PDSCH may be referred to as data.

Hereinafter, in the disclosure, higher layer signaling is a method for transmitting, by a base station, a signal to a terminal by using a downlink data channel of a physical layer or a method for transmitting, by a terminal, a signal to a base station by using an uplink data channel of a physical layer. The higher layer signaling may also be referred to as RRC signaling or MAC control element (CE).

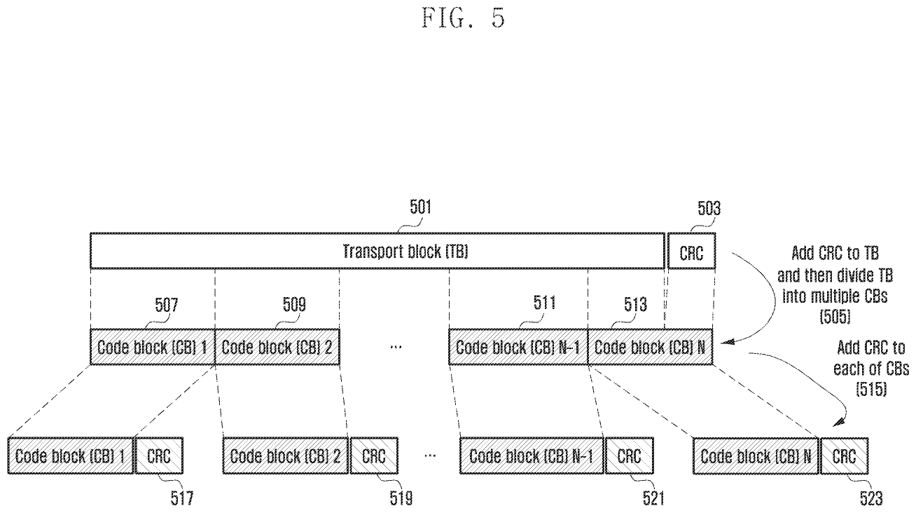

FIG. 5 illustrates an example of a process in which one transport block is divided into multiple code blocks and CRCs are added thereto.

Referring to FIG. 5, a CRC 503 may be added to the last part or the first part of one transport block (TB) 501 to be transmitted in an uplink or a downlink. The CRC 503 may have 16 bits, 25 bits, or a pre-fixed number of bits, or may have a variable number of bits depending on channel conditions, and may be used to determine whether channel coding is successful. A block including the TB 501 and the CRC 503 added thereto may be divided into multiple code blocks (CBs) 507, 509, 511, and 513 (indicated by reference numeral 505). Here, the divided code blocks may have a predetermined maximum size, and in this case, the last code block 513 may be smaller in size than those of other code blocks 507, 509, and 511. However, this is only an example, and according to another example, by inserting zeros, random values, or ones to the last code block 513, the length of the last code block 513 may be adjusted to be the same as that of the other code blocks 507, 509, and 511.

In addition, CRCs 517, 519, 521, and 523 may be added to the code blocks 507, 509, 511, and 513, respectively (indicated by reference numeral 515). The CRCs may include 16 bits, 24 bits, or a pre-fixed number of bits, and may be used to determine whether channel coding is successful.

The TB 501 and a cyclic generator polynomial may be used in order to generate the CRC 503, and the cyclic generator polynomial may be defined in various methods. For example, assuming that a cyclic generator polynomial for a 24-bit CRC is gCRC24A(D)=D²⁴+D²³+D¹⁸+D¹⁷+D¹⁴+D¹¹+D¹⁰+D⁷+D⁶+D⁵+D⁴+D³+D+1 and L=24, a CRC p₀, p₁, p₂, p₃, . . . , p_{L-1} may be determined, with respect to TB data a₀, a₁, a₂, a₃, . . . , a_{A-1}, to be a value obtained by dividing a_{0D}^{A+23}+a₁D^{A+22}+ . . . +a_{A-1}D²⁴+p₀D²³+p₁D³³+ . . . +p₂₂D¹+p₂₃ by gCRC24A(D) with a remainder of 0. In the above example, the CRC length “L” is assumed to be 24 as an example, but the CRC length “L” may be determined to have different lengths, such as 12, 16, 24, 32, 30, 48, 64, and the like.

Through this process, the CRC is added to the TB, and then the TB having CRC added thereto may be divided into N CBs 507, 509, 511, and 513. CRCs 517, 519, 521, and 523 may be added to each of the divided CBs 507, 509, 511, and 513 (indicated by reference numeral 515). The CRCs added to the CBs may have a different length than that of the CRC added to the TB or may use a different cyclic generator polynomial. In addition, the CRC 503 added to the TB and the CRCs 517, 519, 521, and 523 added to the code blocks may be omitted depending on the type of a channel code to be applied to the code block. For example, if LDPC codes other than turbo codes are applied to code blocks, CRCs 517, 519, 521, and 523 to be inserted for each code block may be omitted.

However, even if the LDPC is applied, the CRCs 517, 519, 521, and 523 may be added to the code block as they are. In addition, CRC may be added or omitted even if a polar code is used.

As described above in FIG. 5, the maximum length of one code block is determined according to the type of channel coding applied to a TB to be transmitted, and the TB and CRC, which is added to the TB, are divided into code blocks according to the maximum length of the code block.

In the conventional LTE system, CRC for CB is added to the divided CB, data bits and the CRC of the CB are encoded with a channel code, and thus coded bits are determined and a number of bits, which have undergone predetermined rate matching to each of coded bits, may be determined.

The size of TB in the NR system may be calculated through the following operations.

Operation 1: N′_{RE}, which is the number of REs assigned to PDSCH mapping in one PRB in the assigned resource, is calculated. N′_{RE} may be calculated by N_{sc}^{RB}·N_{symb}^{sh}−N_{DMRS}^{PRB}−Nₒₕ^{PRB}. Here, N_{sc}^{RB} is 12, and N_{symb}^{sh} may represent the number of OFDM symbols allocated to the PDSCH. N_{DMRS}^{PRB} is the number of REs in one PRB occupied by DMRSs of the same CDM group. Nₒₕ^{PRB} is the number of REs occupied by the overhead in one PRB, which is configured via higher layer signaling, and may be configured to be one of 0, 6, 12, or 18. Thereafter, N_{RE}, which is the total number of REs, allocated to the PDSCH may be calculated. N_{RE} is calculated by min(156,N′_{RE})·n_{PRB}, and n_{PRB} denotes the number of PRBs allocated to a terminal.

Operation 2: N_{info}, which is the number of temporary information bits, may be calculated by N_{RE}*R*Qₘ*v. Here, R is a code rate, Qₘ is a modulation order, and information of this value may be transferred using a predefined table and an MCS bit field of DCI. In addition, v is the number of assigned layers. In a case of N_{info}≤3824, TBS may be calculated through operation 3 below. Otherwise, TBS may be calculated through operation 4.

Operation 3: N′_{info} may be calculated by the equation of

$${N}_{info}^{′} = max ( 24 , {2}^{n} * ⌊ \frac{{N}_{info}}{{2}^{n}} ⌋ )$$

and n=max(3,└ log₂(N_{info})−6┘. TBS may be determined as a value, which is the closest to N′_{info} among values equal to or greater than N′_{info} in Table 12 below.

TABLE 12

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

Operation 4: N′_{info} may be calculated by the equation of

$${N}_{info}^{′} = max ( 3840 , {2}^{n} \times round ( \frac{{N}_{info} - 24}{{2}^{n}} ) )$$

and n=└ log₂(N_{info}−24)┘−5. TBS may be determined through a value of N′_{info} and the following [pseudo-code 1]. In the following, C corresponds to the number of code blocks which one TB includes.

```
[Start Pseudo-code 1]
if R ≤ 1/4
  $T B S = 8 \cdot C \cdot ⌈ \frac{{N}_{info}^{′} + 24}{8 \cdot C} ⌉ - 24 , where C = ⌈ \frac{{N}_{info}^{′} + 24}{3816} ⌉$
else
  if N_{info}′ > 8424
  $TBS = 8 \cdot C \cdot ⌈ \frac{{N}_{info}^{′} + 24}{8 \cdot C} ⌉ - 24 , where C = ⌈ \frac{{N}_{info}^{′} + 24}{8424} ⌉$
  else
  $T B S = 8 \cdot ⌈ \frac{{N}_{info}^{′} + 24}{8} ⌉ - 24$
  end if
end if
[End Pseudo-code 1]
```

In the NR system, if one CB is input to an LDPC encoder, parity bits may be added to the CB and the CB added with the parity bits may be output. The amount of parity bits may differ according to an LDPC base graph. A method of transmitting all parity bits, generated by LDPC coding for a specific input, may be called full buffer rate matching (FBRM), and a method of limiting the number of parity bits that can be transmitted may be called limited buffer rate matching (LBRM). If resources are allocated for data transmission, the output of the LDPC encoder is made using a circular buffer, and bits of the buffer are repeatedly transmitted as many times as the number of the allocated resources is transmitted, and the length of the circular buffer may be denoted by N_{ab}.

When the number of parity bits generated by LDPC coding is N, N_{cb}=N may be satisfied in the FBRM method. In the LBRM method, N_{cb}=min(N, N_{ref}) may be satisfied, N_{ref} is given by

$$⌊ \frac{{TBS}_{LBRM}}{C \cdot {R}_{LBRM}} ⌋ ,$$

and R_{LBRM} may be determined to be ⅔. In order to calculate TBS_{LBRM}, the method for obtaining the TBS described above is used. Here, the maximum modulation order and the maximum number of layers supported by a terminal in the corresponding cell are assumed. When it is configured to use an MCS table supporting 256QAM for at least one BWP in the corresponding cell, the maximum modulation order Qₘ is assumed to be “8”, and if not, the maximum modulation order Qₘ is assumed to be 6 (64QAM), the code rate is assumed to be 948/1024 that is the maximum code rate, N_{RE} is assumed to satisfy 156·n_{PRB}, and n_{PRB} is assumed to satisfy n_{PRB,LBRM}. Values of n_{PRB,LBRM} may be given as in Table 13 below.

TABLE 13

| Maximum number of PRBs | |
|---|---|
| across all configured | |
| BWPs of a carrier | n_{PRB, LBRM} |
| less than 33 | 32 |
| 33 to 66 | 66 |
| 67 to 107 | 107 |
| 108 to 135 | 135 |
| 136 to 162 | 162 |
| 163 to 217 | 217 |
| larger than 217 | 273 |

In the NR system, the maximum data rate supported by the terminal may be determined through Equation 2 below.

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( i )} \cdot {R}_{max} \cdot \frac{{N}_{PRB}^{BW ( j ) , μ} \cdot 12}{{T}_{S}^{μ}} \cdot ( 1 - {OH}^{( j )} ) ) \qquad Equation 2$$

In Equation 2, J may denote the number of carriers grouped by carrier aggregation, Rₘₐₓ=948/1024, v_{Layers}^{(j)} may denote the maximum number of layers, Qₘ^{(j)} may denote a maximum modulation order, f^{(j)} may denote a scaling index, and μ may denote a subcarrier spacing. The terminal may report f^{(j)} as one value among 1, 0.8, 0.75, and 0.4, and μ may be given as shown in Table 14 below.

TABLE 14

| μ | Δf = 2^{μ} · 15(kHz) | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Further, Tₛ^{μ} denotes an average OFDM symbol length, Tₛ^{μ} may be calculated according to 10⁻³/14·2^{μ}, and N_{PRR}^{BW(j),μ} may denote the maximum number of RBs in BW (j). OH^{(j)} is an overhead value, and OH^{(j)} may be given as 0.14 in the downlink of FR1 (a band equal to or less than 6 GHz) and given as 0.18 in the uplink thereof, and may be given as 0.08 in the downlink of FR2 (a band above 6 GHz) and given as 0.10 in the uplink thereof. Through Equation 2, the maximum data rate in the downlink in a cell having a 100 MHz frequency bandwidth at a 30 kHz subcarrier spacing may be calculated as shown in Table 15 below.

TABLE 15

| f^{(j)} | [symbol] | Q [symbol] | Rmax | N [symbol] | Tₛ^{μ} | OH^{(j)} | data rate |
|---|---|---|---|---|---|---|---|
| 1 | 4 | 8 | 0.92578125 | 273 | 3.57143E− | 0.14 | 2337.0 |
| | | | | | 05 | | |
| 0.8 | 4 | 8 | 0.92578125 | 273 | 3.57143E− | 0.14 | 1869.6 |
| | | | | | 05 | | |
| 0.75 | 4 | 8 | 0.92578125 | 273 | 3.57143E− | 0.14 | 1752.8 |
| | | | | | 05 | | |
| 0.4 | 4 | 8 | 0.92578125 | 273 | 3.57143E− | 0.14 | 934.8 |
| | | | | | 05 | | |

[symbol]

indicates data missing or illegible when filed

On the other hand, an actual data rate of a terminal, which may be measured in actual data transmission, may be a value obtained by dividing the amount of data by the data transmission time. This may be a value obtained by dividing a TBS in 1 TB transmission or a sum of TBSs in 2 TB transmission, by the TTI length. For example, as in the assumption shown in Table 15, the actual maximum data rate in a downlink in a cell having a 100 MHz frequency bandwidth at a 30 kHz subcarrier spacing may be determined as shown in Table 16 below according to the number of allocated PDSCH symbols.

TABLE 16

| | | | | | | | | | TTI | |
|---|---|---|---|---|---|---|---|---|---|---|
| | | | | | | | | | length | data rate |
| N_{symb}^{s} [symbol] | N_{DMRS}^{PRB} | N [symbol] _{RE} | N_{RE} | N_{info} | n | N′_{info} | C | TBS | (ms) | (Mbps) |
| 3 | 8 | 28 | 7644 | 226453.5 | 12 | 225,280 | 27 | 225,480 | 0.107143 | 2,104.48 |
| 4 | 8 | 40 | 10920 | 323505.0 | 13 | 319,488 | 38 | 319,784 | 0.142857 | 2,238.49 |
| 5 | 8 | 52 | 14196 | 420556.5 | 13 | 417,792 | 50 | 417,976 | 0.178571 | 2,340.67 |
| 6 | 8 | 64 | 17472 | 517608.0 | 13 | 516,096 | 62 | 516,312 | 0.214286 | 2,409.46 |
| 7 | 8 | 76 | 20748 | 614659.5 | 14 | 622,592 | 74 | 622,760 | 0.250000 | 2,491.04 |
| 8 | 8 | 88 | 24024 | 711711.0 | 14 | 704,512 | 84 | 704,904 | 0.285714 | 2,467.16 |
| 9 | 8 | 100 | 27300 | 808762.5 | 14 | 802,816 | 96 | 803,304 | 0.321429 | 2,499.17 |
| 10 | 8 | 112 | 30576 | 905814.0 | 14 | 901,120 | 107 | 901,344 | 0.357143 | 2,523.76 |
| 11 | 8 | 124 | 33852 | 1002865.5 | 14 | 999,424 | 119 | 999,576 | 0.392857 | 2,544.38 |
| 12 | 8 | 136 | 37128 | 1099917.0 | 15 | 1,114,112 | 133 | 1,115,048 | 0.428571 | 2,601.78 |
| 13 | 8 | 148 | 40404 | 1196968.5 | 15 | 1,212,416 | 144 | 1,213,032 | 0.464286 | 2,612.68 |
| 14 | 8 | 160 | 43680 | 1294020.0 | 15 | 1,277,952 | 152 | 1,277,992 | 0.500000 | 2,555.98 |

[symbol]

indicates data missing or illegible when filed

The maximum data rate supported by the terminal may be identified through Table 15, and the actual data rate according to the assigned TBS may be identified through Table 16. Here, the actual data rate may be greater than the maximum data rate depending on scheduling information.

In a wireless communication system, especially in an NR system, a data rate supportable by a terminal may be agreed between a base station and a terminal. The data rate may be calculated using the maximum frequency band, the maximum modulation order, and the maximum number of layers, which are supported by the terminal. However, the calculated data rate may be different from a value calculated based on a TBS and a transmission time interval (TTI) length used for actual data transmission.

Accordingly, a case, in which a terminal is assigned a TBS greater than a value corresponding to a data rate supported by the terminal itself, may occur. In order to prevent this case from occurring, there may be a restriction on schedulable TBSs according to the data rate supported by the terminal.

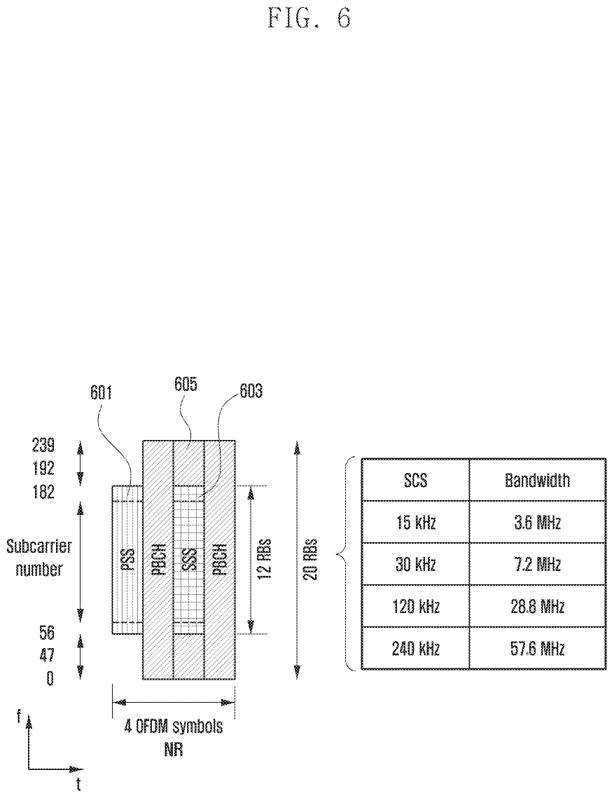

FIG. 6 illustrates an aspect in which a synchronization signal (SS) and a physical broadcast channel (PBCH) of an NR system are mapped in a frequency and a time domain.

A PSS 601, an SSS 603, and the PBCH are mapped over 4 OFDM symbols, the PSS and the SSS are mapped to 12 RBs, and the PBCH is mapped to 20 RBs. A table in FIG. 6 shows that frequency bands of 20 RBs change according to a subcarrier spacing (SCS). A resource domain in which the PSS, the SSS, and the PBCH are transmitted may be called a SS/PBCH block. In addition, the SS/PBCH block may be referred to as an SSB block.

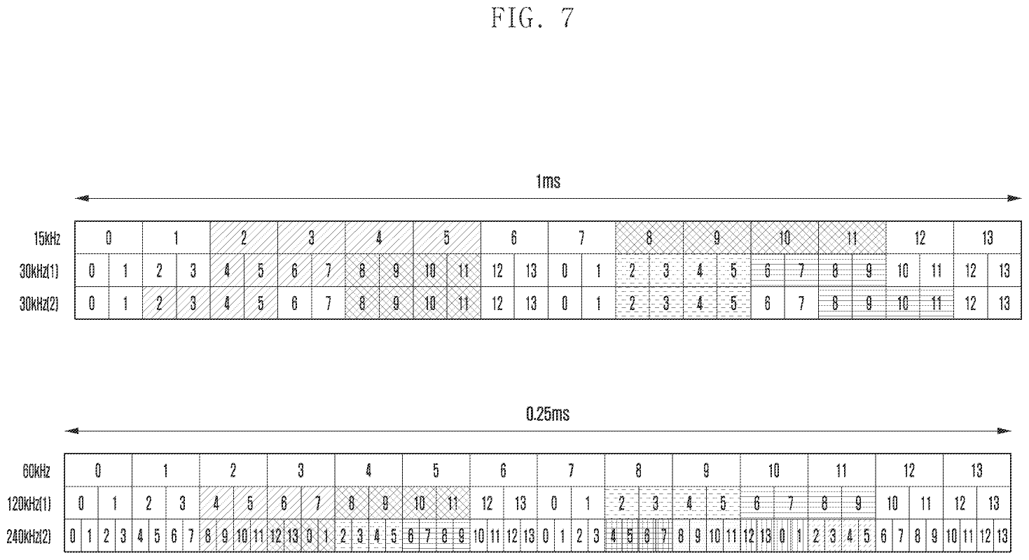

FIG. 7 illustrates symbols to which an SS/PBCH block can be transmitted according to a subcarrier spacing.

Referring to FIG. 7, the subcarrier spacing may be configured as 15 kHz, 30 kHz, 120 kHz, 240 kHz, and the like, and the position of a symbol, in which the SS/PBCH block (or SSB block) can be located, may be determined according to each subcarrier spacing. FIG. 7 illustrates the position of a symbol through which an SSB can be transmitted according to a subcarrier spacing in symbols within 1 ms, and the SSB in the region shown in FIG. 7 is not always required to be transmitted. Accordingly, the position where the SSB block is transmitted may be configured for a terminal through system information or dedicated signaling.

Since a terminal is generally located away from a base station, a signal transmitted by the terminal is received by the base station after a propagation delay. The propagation delay may be regarded as a value obtained by dividing a path through which radio waves are transmitted from the terminal to the base station by the speed of light, and may generally be regarded as a value obtained by dividing a distance from the terminal to the base station by the speed of light. In an embodiment, in a case of a terminal located 100 km away from the base station, a signal transmitted from the terminal is received by the base station after about 0.34 msec. On the other hand, a signal transmitted from the base station is also received by the terminal after about 0.34 msec. As described above, a timing at which a signal transmitted from the terminal arrives at the base station may differ according to the distance between the terminal and the base station. Therefore, when multiple terminals existing in different locations transmit signals at the same time, a timing at which signals arrive at the base station may all be different. In order to solve this problem and to allow signals transmitted from multiple terminals to arrive at the base station at the same time, a timing for transmission of the uplink signal may be different according to the position of each terminal. In 5G, NR, and LTE systems, this is called a timing advance (TA).

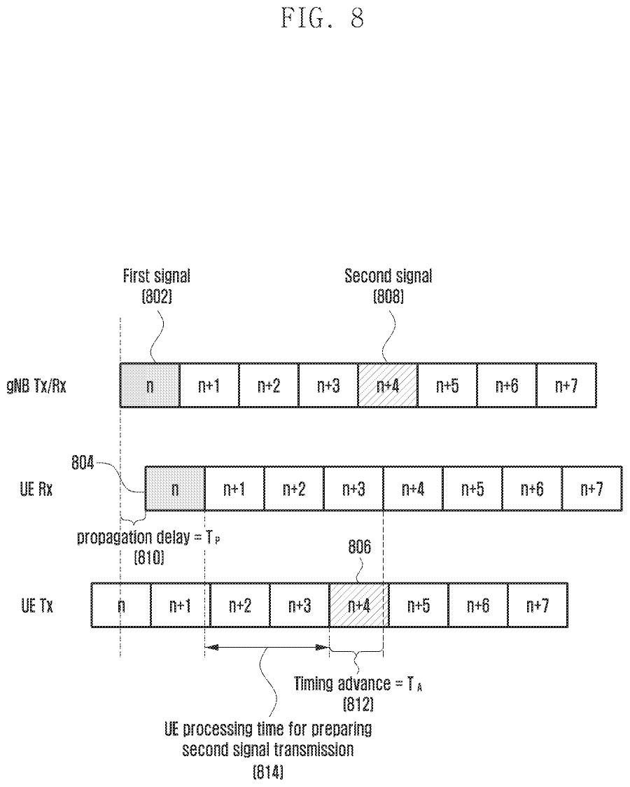

FIG. 8 illustrates a UE processing time according to a timing advance when the a UE receives a first signal and then transmits a second signal thereto in a 5G or NR system according to a disclosed embodiment.

Hereinafter, a UE processing time according to a timing advance will be described in detail. When a base station transmits an uplink scheduling grant (UL grant) or a downlink control signal and data (DL grant and DL data) to a UE in slot n 802, the UE may receive the UL scheduling grant or the downlink control signal and data in slot n 804. In this case, the UE may receive the signal later by propagation delay (Tₚ) 810 than a timing at which the base station has transmitted the signal. In this embodiment, when the UE has received a first signal in slot n 804, the UE transmits a second signal corresponding thereto in slot (n+4) 806. Even when the UE transmits a signal to the base station, in order for the base station to receive the signal at a specific timing, the UE may transmit the HARQ ACK/NACK for uplink data or downlink data at the timing 806 which is earlier by a timing advance (TA) 812 than the slot (n+4) based on the received signal. Therefore, in this embodiment, a preparation time of the UE for transmitting uplink data after receiving the UL scheduling grant or for transferring the HARQ ACK or NACK after receiving the downlink data may correspond to a timing obtained by subtracting the TA from a timing corresponding to three slots (indicated by reference numeral 814).

In order to determine the above-described timing, the base station may calculate the absolute value of TA of the corresponding UE. The base station may calculate the absolute value of TA by adding or subtracting, to or from a TA value initially delivered to the initially accessed UE at the random access stage, a TA value variation subsequently transferred via higher layer signaling. In the disclosure, the absolute value of the TA may be a value obtained by subtracting a start time of the nth TTI received by the UE from a start time of the nth TTI transmitted by the UE.

Meanwhile, one of the important criteria for the performance of a cellular wireless communication system is packet data latency. To this end, in the LTE system, signal transmission and reception are performed in units of subframes having a TTI of 1 ms. In the LTE system operating as described above, a UE having a transmission time interval shorter than 1 ms (short-TTI UE) may be supported. On the other hand, in 5G or NR system, the transmission time interval may be shorter than 1 ms. The short-TTI UE is suitable for services such as voice over LTE (VoLTE) service and a remote control, in which latency is important. In addition, the short-TTI UE becomes a measure for realizing a mission-critical Internet of things (IoT) on a cellular basis.

In a 5G or NR system, when a PDSCH including downlink data is transmitted, the base station may indicate a value K1, which is a value corresponding to information about a timing at which the UE transmits HARQ-ACK information of the PDSCH, in DCI for scheduling the PDSCH. When the HARQ-ACK information includes a timing advance and is not indicated to be transmitted prior to a symbol L1, the UE may transmit the HARQ-ACK information to the base station. That is, the HARQ-ACK information may include a timing advance, and may be transmitted from the UE to the base station at the timing identical to or later than the symbol L1. When the HARQ-ACK information including a timing advance is indicated to be transmitted prior to the symbol L1, the HARQ-ACK information may not be valid HARQ-ACK information during HARQ-ACK transmission from the UE to the base station.

The symbol L1 may be the first symbol in which a cyclic prefix (CP) starts after T_{proc,1} from the last timing of the PDSCH. T_{proc,1} may be calculated according to Equation 3 below.

T_{proc,1}=((N₁+d_{1,1}+d_{1,2})(2048+144)·κ2^{-μ})·T_{C} Equation 3

In Equation 3 above, N₁, d₁, 1, d_{1,2}, κ, μ, and TC may be defined as follows.
When the HARQ-ACK information is transmitted through a PUCCH (uplink control channel), d_{1,1}=0, and when the HARQ-ACK information is transmitted through a PUSCH (uplink shared channel or data channel), d_{1,1}=1.
When the UE is configured with a plurality of activated component carriers or carriers, a maximum timing difference between carriers may be reflected in transmission of a second signal.
For PDSCH mapping type A, that is, in a case where the position of the first DMRS symbol is the third or fourth symbol of the slot, if the position index i of the last symbol of the PDSCH is smaller than 7, it may be defined that d_{1,2}=7−i.
For PDSCH mapping type B, that is, in a case where the position of the first DMRS symbol is the first symbol of the PDSCH, if the length of the PDSCH is 4 symbols, d_{1,2}=3, and if the length of the PDSCH is 2 symbols, d_{1,2}=3+d, where d denotes the number of symbols in which the PDSCH and the PDCCH including the control signal for scheduling the corresponding PDSCH overlap.
N₁ is defined as in Table 17 below according to μ. μ=0, 1, 2, and 3 refer to subcarrier spacing of 15 kHz, 30 kHz, 60 kHz, and 120 kHz, respectively.

TABLE 17

PDSCH decoding time N₁ (symbols)

| | No additional PDSCH | Additional PDSCH |
|---|---|---|
| μ | DMRS configured | DMRS configured |
| 0 | 8 | 13 |
| 1 | 10 | 13 |
| 2 | 17 | 20 |
| 3 | 20 | 24 |

For the N₁ value provided in Table 17 above, different values may be used according to UE capability.
T_{c}=1/(Δfₘₐₓ·N_{f}), Δf=480·10³ Hz, N_{f}=4096, κ=T_{S}/T_{c}=64, T_{S}=1/(Δf_{ref}·N_{f,ref}), Δf_{ref}=15·10³ Hz, N_{f,ref}=2048 are defined, respectively.

In addition, in the 5G or NR system, when a base station transmits control information including a UL scheduling grant, the UE may indicate a value K2 corresponding to timing information for transmission of UL data or PUSCH.

When the PUSCH includes a timing advance and is not indicated to be transmitted prior to a symbol L2, the UE may transmit the PUSCH to the base station. That is, the PUSCH may include a timing advance, and may be transmitted from the UE to the base station at a timing identical to or later than the symbol L2. When the PUSCH includes a timing advance and is indicated to be transmitted prior to the symbol L2, the UE may ignore the UL scheduling grant control information from the base station.

The symbol L2 may be the first symbol in which a CP of the PUSCH symbol to be transmitted after T_{proc,2} from the last timing of the PDCCH including a scheduling grant starts. T_{proc,2} may be calculated according to Equation 4 below.

T_{proc,1}=((N₂+d_{2,1})(2048+144)·κ2^{-μ})·T_{C} Equation 4

In Equation 4 above, N₂, d_{2,1}, κ, μ, and T_{C} may be defined as follows.
If the first symbol among PUSCH-allocated symbols includes only DMRS, d_{2,1}=0, otherwise d_{2,1}=1.
If the UE is configured with a plurality of activated component carriers or carriers, the maximum timing difference between carriers may be reflected in the second signal transmission.
N2 is defined as in Table 18 below according to μ. μ=0, 1, 2, and 3 refer to subcarrier spacing of 15 kHz, 30 kHz, 60 kHz, and 120 kHz, respectively.

TABLE 18

| | PUSCH preparation |
|---|---|
| μ | time N₂ (symbols) |
| 0 | 10 |
| 1 | 12 |
| 2 | 23 |
| 3 | 36 |

For the value N₂ provided in Table 18 above, a different value may be used according to UE capability.
T_{c}=1/(Δfₘₐₓ·N_{f}), Δf=480·10³ Hz, N_{f}=4096, κ=T_{S}/T_{c}=64, T_{S}=1/(Δf_{ref}·N_{f,ref}), Δf_{ref}=15·10³ Hz, N_{f,ref}=2048 may be defined, respectively.

On the other hand, the 5G or NR system may configure a frequency band part (BWP) within one carrier so as to designate a specific terminal to perform transmission and reception in the configured BWP. This may be performed to reduce power consumption of the terminal. The base station may configure a plurality of BWPs, and may change an activated BWP using the control information. A timing that the terminal may use to change a BWP may be defined as shown in Table 19 below.

TABLE 19

| Frequency | | type 1 delay | type 2 delay |
|---|---|---|---|
| range | scenario | (us) | (us) |
| 1 | 1 | 600 | 2000 |
| | 2 | 600 | 2000 |
| | 3 | 600 | 2000 |
| | 4 | 600 | 950 |
| 2 | 1 | 600 | 2000 |
| | 2 | 600 | 2000 |
| | 3 | 600 | 2000 |
| | 4 | 600 | 950 |

In Table 19, frequency range 1 may denote a frequency band of 6 GHz or less, and frequency range 2 may denote a frequency band of 6 GHz or greater. In the above-described embodiment, type 1 and type 2 may be determined according to UE capability. In the above-described embodiment, scenarios 1, 2, 3 and 4 are given as shown in Table 20 below.

TABLE 20

| | Center frequency | Center frequency |
|---|---|---|
| | is changeable | is unchangeable |
| Frequency bandwidth | Scenario 3 | Scenario 2 |
| is changeable | | |
| Frequency bandwidth | Scenario 1 | scenario 4 in case of |
| is unchangeable | | changing in subcarrier |
| | | spacing |

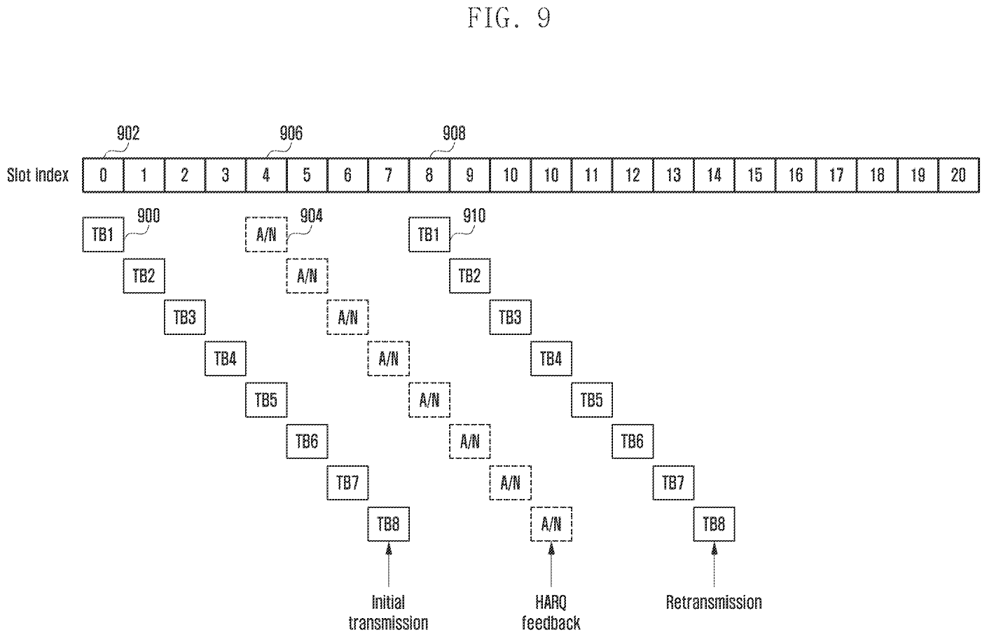

FIG. 9 illustrates an example of scheduling and transmitting pieces of data (e.g., TBs) according to a slot, receiving HARQ-ACK feedback for the corresponding data, and performing retransmission according to the feedback. In FIG. 9, TB1 900 is initially transmitted in slot 0 902, and ACK/NACK feedback 904 relating thereto is transmitted in slot 4 906. If the initial transmission of TB1 fails and a NACK is received, retransmission 910 for TB1 may be performed in slot 8 908. In the above, a timing at which the ACK/NACK feedback is transmitted and a timing at which the retransmission is performed may be predetermined or may be determined according to a value indicated by control information and/or higher layer signaling.

FIG. 9 shows an example in which TB1 to TB8 are sequentially scheduled according to a slot from slot 0 and transmitted. For example, HARQ process IDs 0 to 7 may be assigned to TB1 to TB8 and transmitted. If only four HARQ process IDs are usable by the base station and the UE, transmission of 8 different TBs may not be successively performed.

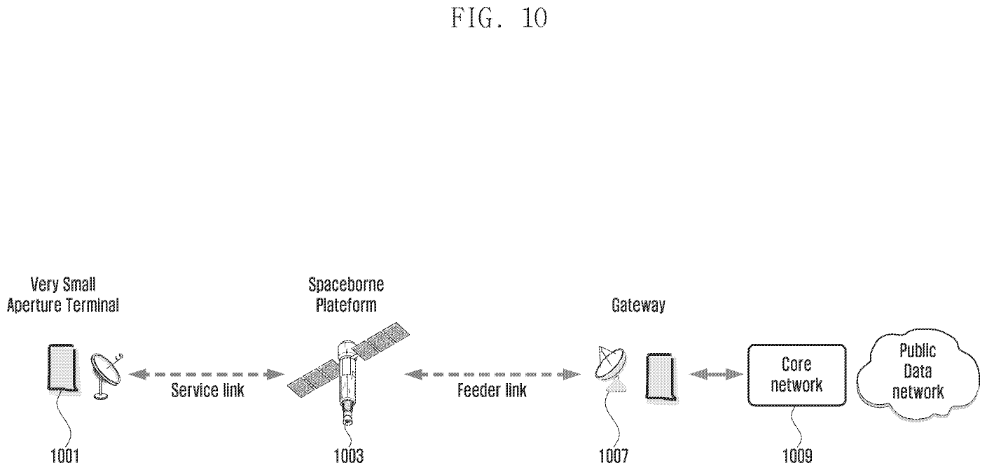

FIG. 10 illustrates an example of a communication system using a satellite. For example, when a terminal 1001 transmits a signal to a satellite 1003, the satellite 1003 transfers the signal to a base station 1005, and the base station 1005 processes the received signal and transmits a signal including a request for a subsequent operation thereto to the terminal 1001, which may be transmitted again through the satellite 1003. In the above, since a distance is long between the terminal 1001 and the satellite 1003, and a distance is also long between the satellite 1003 and the base station 1005, a timing required for data transmission or reception between the terminal 1001 and the base station 1005 becomes longer.

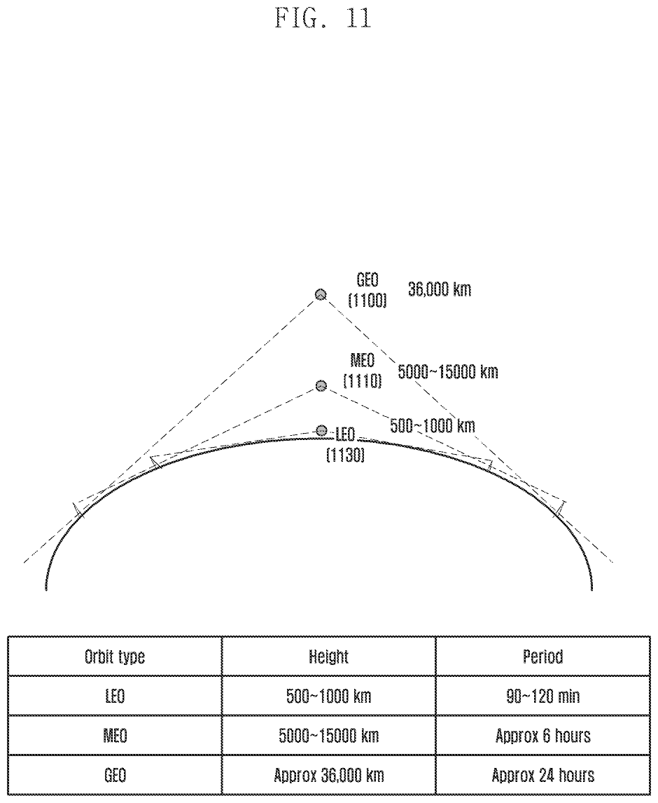

FIG. 11 illustrates a period in which a communication satellite orbits the Earth according to an altitude or height of the satellite. Satellites for communication may be classified into low Earth orbit (LEO), middle Earth orbit (MEO), geostationary Earth orbit (GEO) satellites, and the like according to the orbit of the satellite. In general, a GEO 1100 refers to a satellite of approximately 36000 km in altitude, an MEO 1110 refers to a satellite of an altitude of 5000 to 15000 km, and the LEO refers to a satellite of an altitude of 500 to 1000 km. A period in which the satellite orbits the Earth varies according to each altitude. In a case of the GEO 1100, a period in which the GEO orbits the Earth is about 24 hours, the MEO 1110 has the orbital period of about 6 hours, and the LEO 1130 has the orbital period about 90 to 120 minutes. Due to relatively low altitude, low orbit (˜2,000 km) satellites have advantages in propagation delay and loss compared to geostationary (36,000 km) satellites.

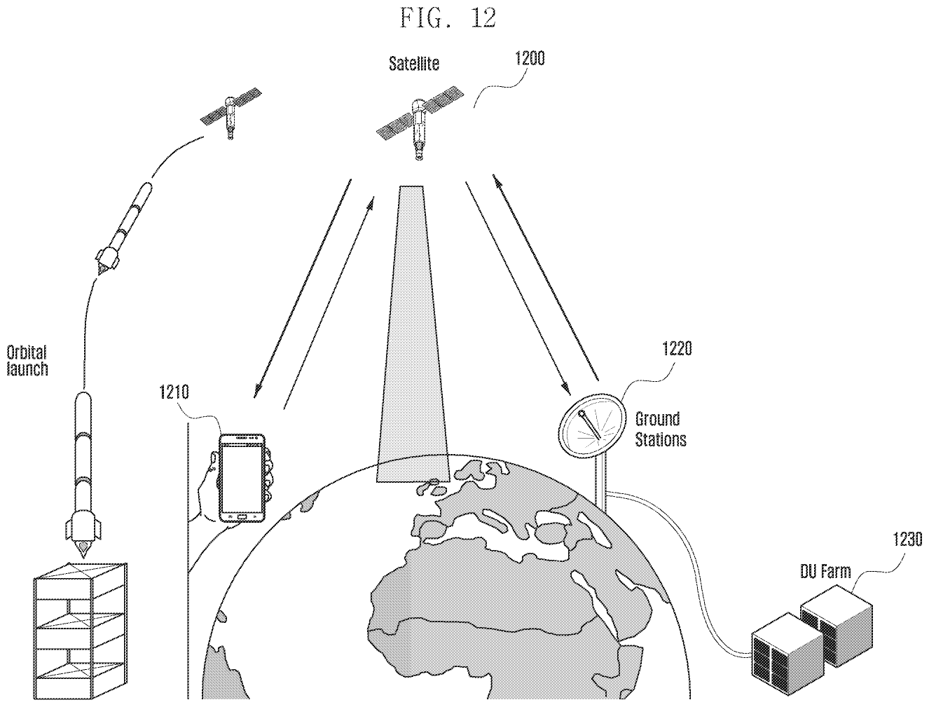

FIG. 12 illustrates a conceptual diagram of satellite-to-terminal communication. A satellite 1200, which is located at the altitude of 100 km or higher by the rocket, transmits or receives a signal to or from a terrestrial terminal 1210, and also transmits or receives a signal to or from a ground station 1220 connected to a terrestrial base station (DU farms) 1230.

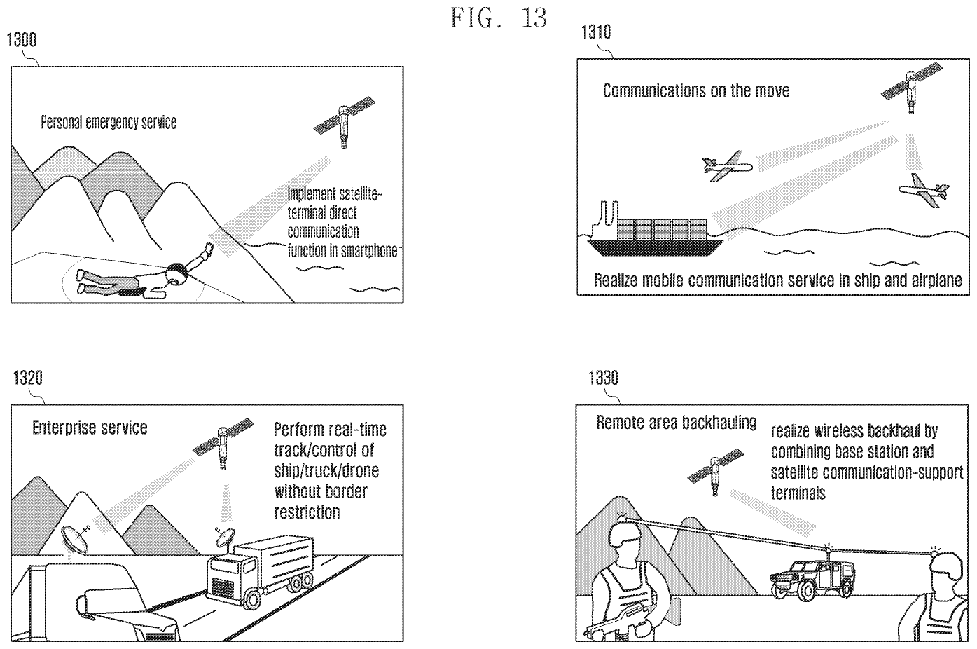

FIG. 13 illustrates a utilization scenario of satellite-terminal direct communication. Satellite-terminal direct communication can support a communication service for specialized purposes in the form of supplementing the coverage limit of the terrestrial network. For example, by implementing the satellite-terminal direct communication function in a user terminal, transmission and reception of the user's emergency rescue and/or disaster signals in places that are not covered by the terrestrial network communication are possible (indicated by reference numeral 1300), a mobile communication service can be provided to a user in an area where terrestrial network communication is impossible, such as a ship and/or an air (indicated by reference numeral 1310), and the location of ships, trucks, and/or drones can be tracked and controlled in real time without border restrictions (indicated by reference numeral 1320). In addition, by supporting the satellite communication function for a base station, it is possible to use the satellite communication to function as a backhaul of the base station and perform the backhaul function when physically distant (indicated by reference numeral 1330).

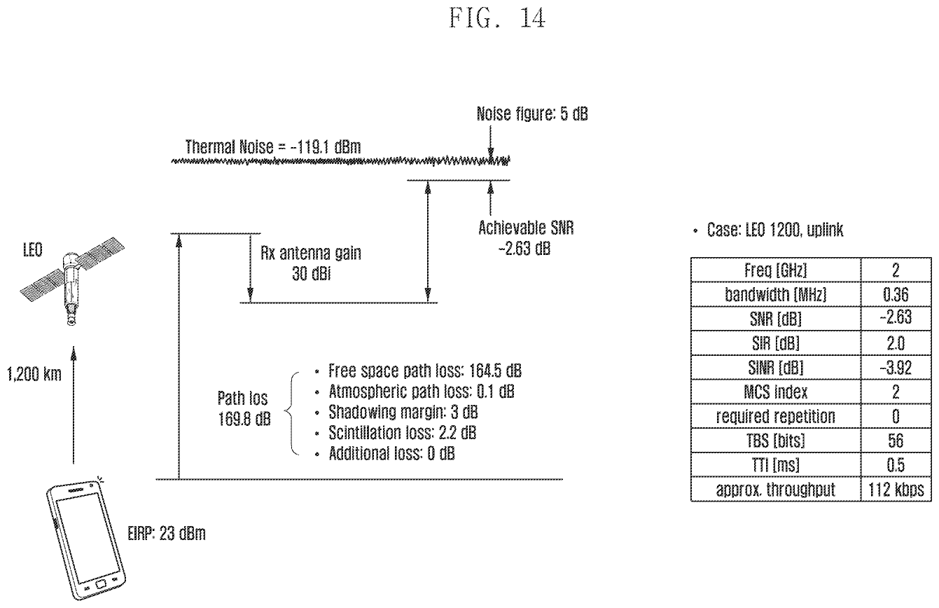

FIG. 14 illustrates an example of calculating an expected data rate (throughput) in an uplink when an LEO satellite at the altitude of 1200 km and a terrestrial terminal perform direct communication. In the uplink, when the transmission effective isotropic radiated power (EIRP) of the terrestrial terminal is 23 dBm, the path loss of the radio channel to the satellite is 169.8 dB, and the satellite reception antenna gain is 30 dBi, the achievable signal-to-noise ratio (SNR) is estimated to be −2.63 dB. Here, the path loss may include a path loss in free space, a loss in the atmosphere, and the like. When a signal-to-interference ratio (SIR) is assumed to be 2 dB, the signal-to-interference and noise ratio (SINR) is calculated as −3.92 dB, and here when using subcarrier spacing of 30 kHz and frequency resources of 1 PRB, it may be possible to achieve a transmission rate of 112 kbps.

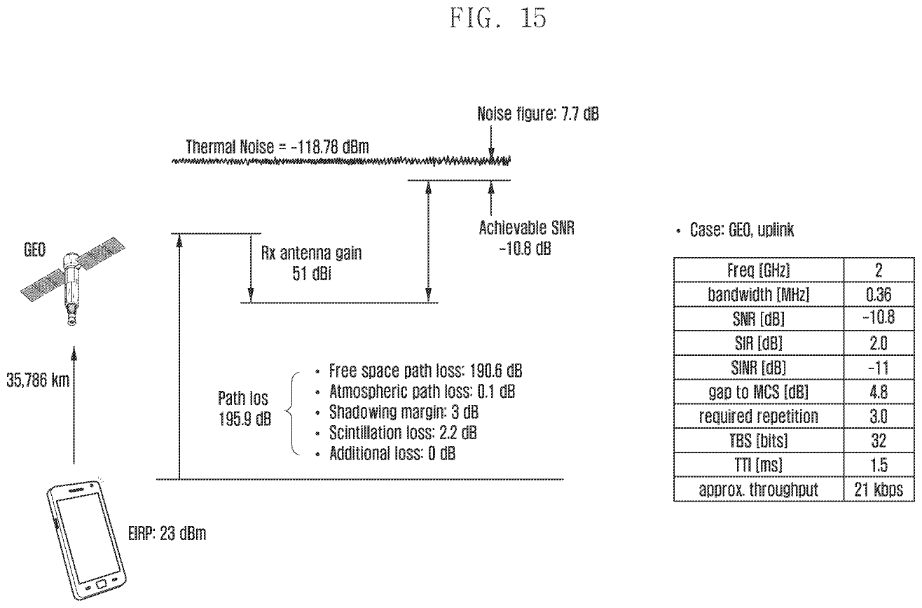

FIG. 15 illustrates an example of calculating an expected data rate (throughput) in an uplink when a GEO satellite at the altitude of 35,786 km and a terrestrial terminal perform direct communication. When the transmission EIRP of the terrestrial terminal in the uplink is 23 dBm, the path loss of the radio channel to the satellite is 195.9 dB, and the satellite reception antenna gain is 51 dBi, the achievable SNR is estimated to be −10.8 dB. Here, the path loss may include a path loss in free space, a loss in the atmosphere, and the like. When an SIR is 2 dB, an SINR is calculated to be −11 dB. Here, when a 30 kHz subcarrier spacing and a frequency resource of 1 PRB are used, a transmission rate of 21 kbps can be achieved, which can be obtained by performing three times of repetitive transmissions.

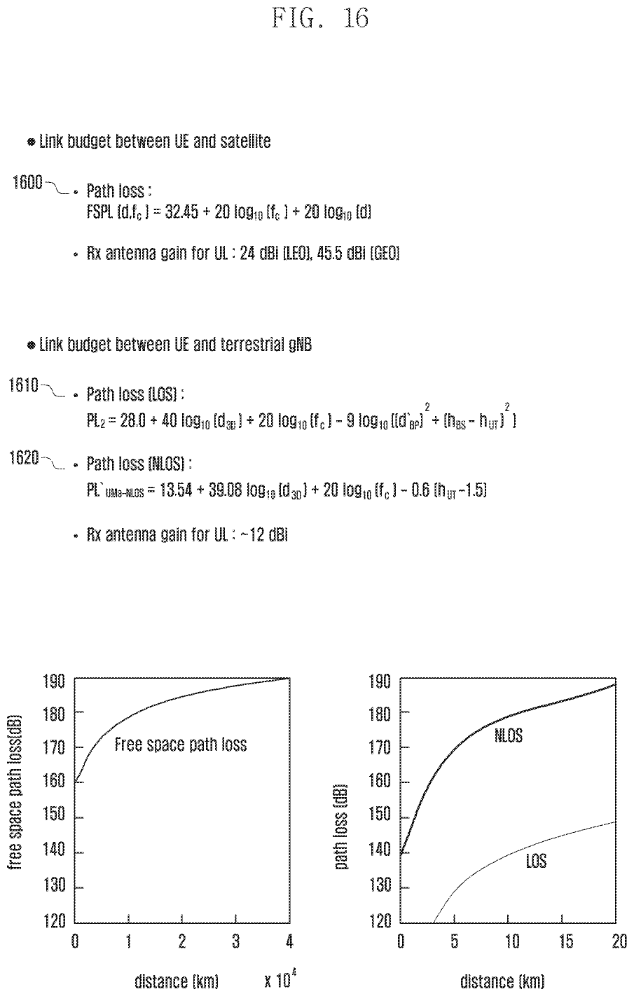

FIG. 16 illustrates a path loss value according to a path loss model between a terminal and a satellite, and a path loss according to a path loss model between a terminal and a terrestrial base station (gNB). In FIG. 16, “d” corresponds to a distance and “f_{c}” is the frequency of a signal. In free space where communication between the terminal and the satellite is performed, a path loss (FSPL) 1600 is inversely proportional to the square of the distance. However, a path loss on the ground including air (PL2, PL′_{Uma-NLOS}) in which communication between the terminal and the terrestrial gNB is performed (indicated by reference numerals 1610 and 1620) is inversely proportional to the fourth power of the distance.

In satellite communications (or non-terrestrial network), a Doppler shift occurs due to the continuous and rapid movement of the satellite, that is, a frequency offset of a transmission signal may occur.

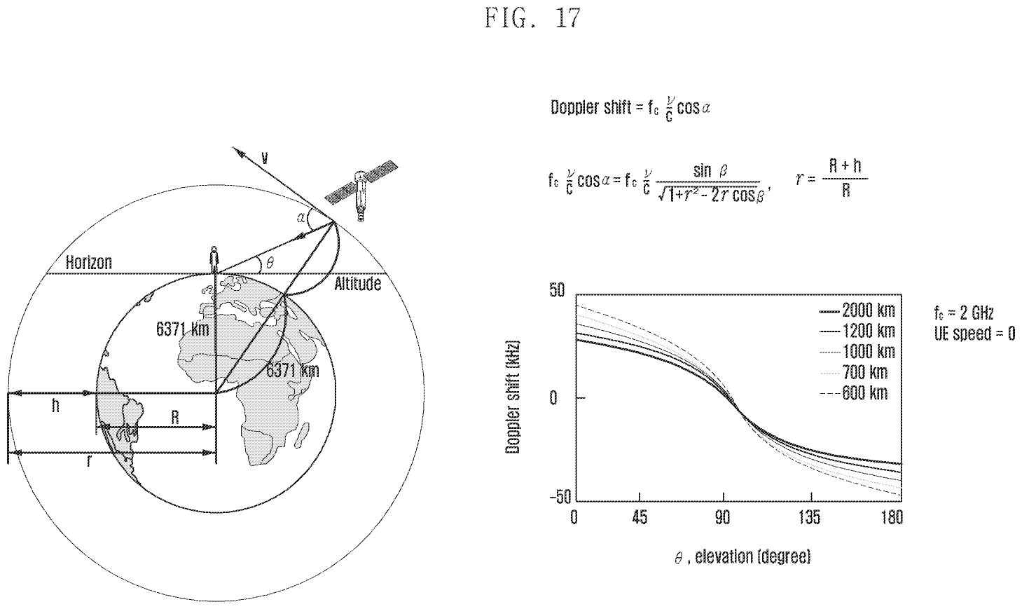

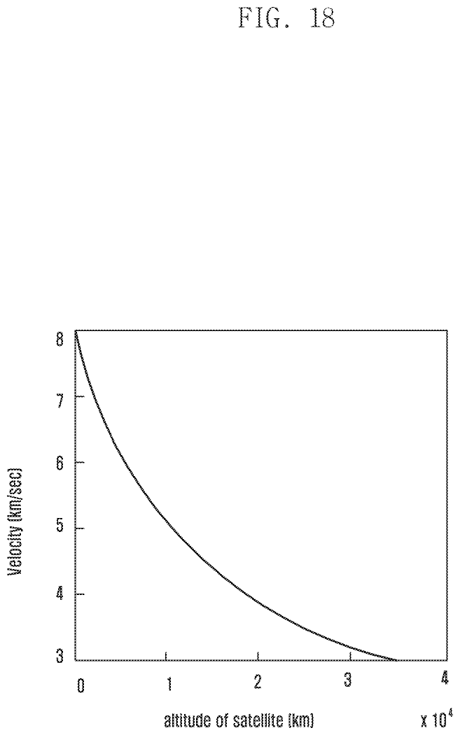

FIG. 17 illustrates equations for calculation of the amount of Doppler shift experienced by a signal, which is transmitted from a satellite and received by a terrestrial user according to the altitude and position of the satellite and the position of a terminal user on the ground, and results thereof. Where the radius of the Earth is “R”, “h” is the altitude of the satellite, “v” is the speed at which the satellite orbits the Earth, and “f_{c}” is the frequency of the signal. The speed of the satellite may be calculated based on the altitude of the satellite, and this resulting that the speed at which gravity, which is a force that the Earth pulls on the satellite, and a centripetal force generated as the satellite orbits become the same, and this can be calculated as shown in FIG. 18. FIG. 18 illustrates the speed of the satellite calculated at the altitude of the satellite. As can be seen from FIG. 17, since each angle α is determined by the elevation angle, the value of the Doppler shift is determined according to the elevation angle θ.

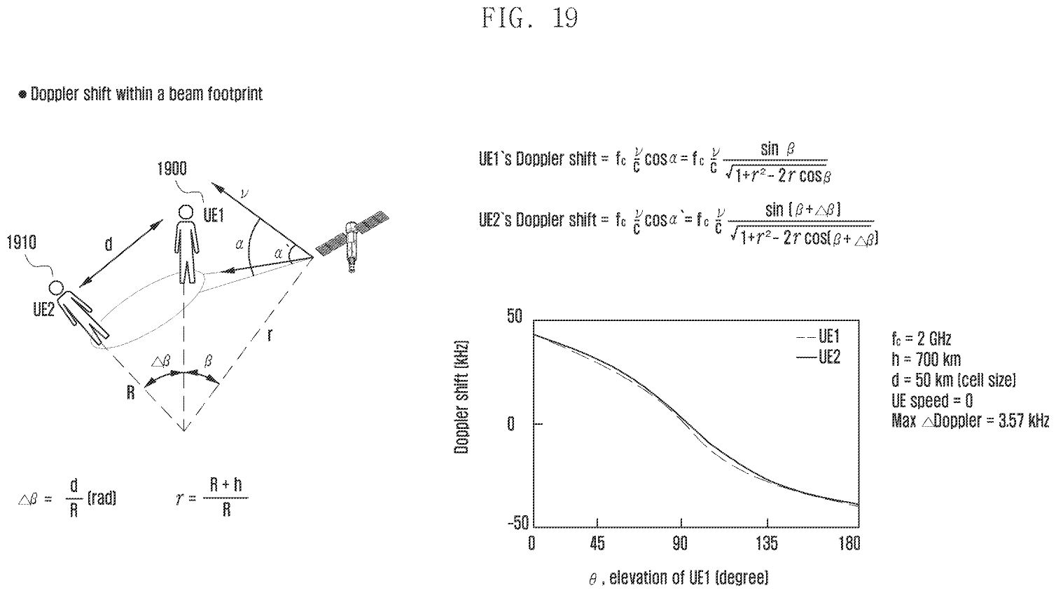

FIG. 19 illustrates Doppler shifts experienced by different terminals within one beam, which is transmitted by a satellite to the ground. In FIG. 19, the Doppler shifts experienced by UE 1 1900 and UE 2 1910 according to the elevation angle θ are calculated, respectively. This is the result obtained under an assumption that the center frequency is 2 GHz, the satellite altitude is 700 km, the diameter of one beam is 50 km on the ground, and the speed of the UE is 0. In addition, the Doppler shift calculated in the disclosure may ignore the effect of the Earth's rotation speed, and this consideration may occur because the Earth's rotation speed is slower than the speed of the satellite.

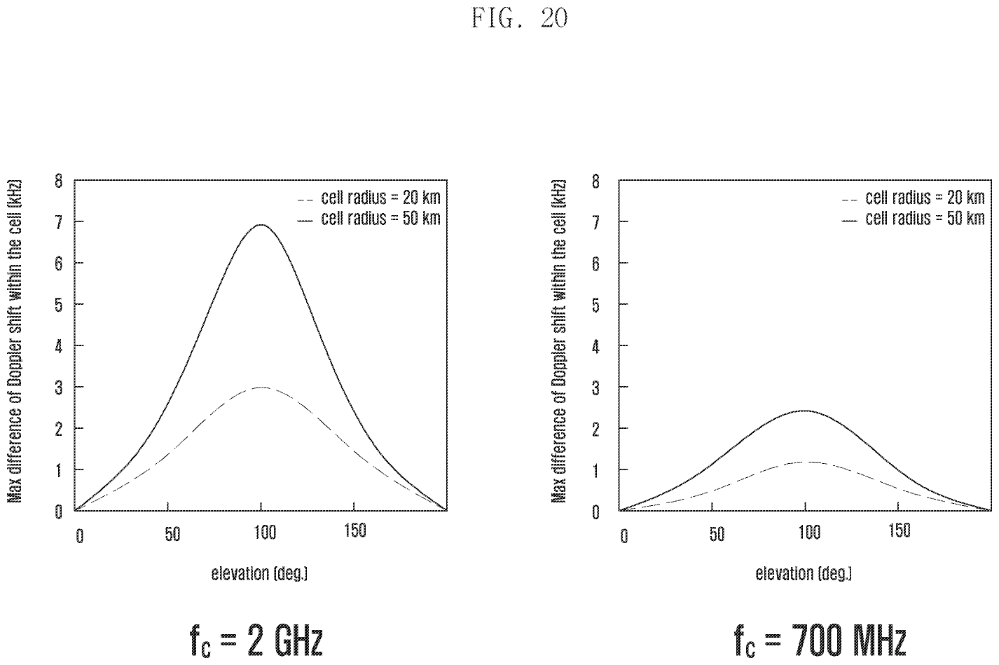

FIG. 20 shows the difference in Doppler shift occurring within one beam according to the position of a satellite determined from an elevation angle. It can be seen that the difference in Doppler shift within the beam (or cell) is the greatest when the satellite is positioned directly above the beam, that is, when the elevation angle is 90 degrees. This may occur because when the satellite is located above the center, the Doppler shift values at one end of the beam and at the other end have positive and negative values, respectively.

On the other hand, in satellite communication, since a satellite is far from a user on the ground, a large latency occurs compared to the terrestrial network communication.

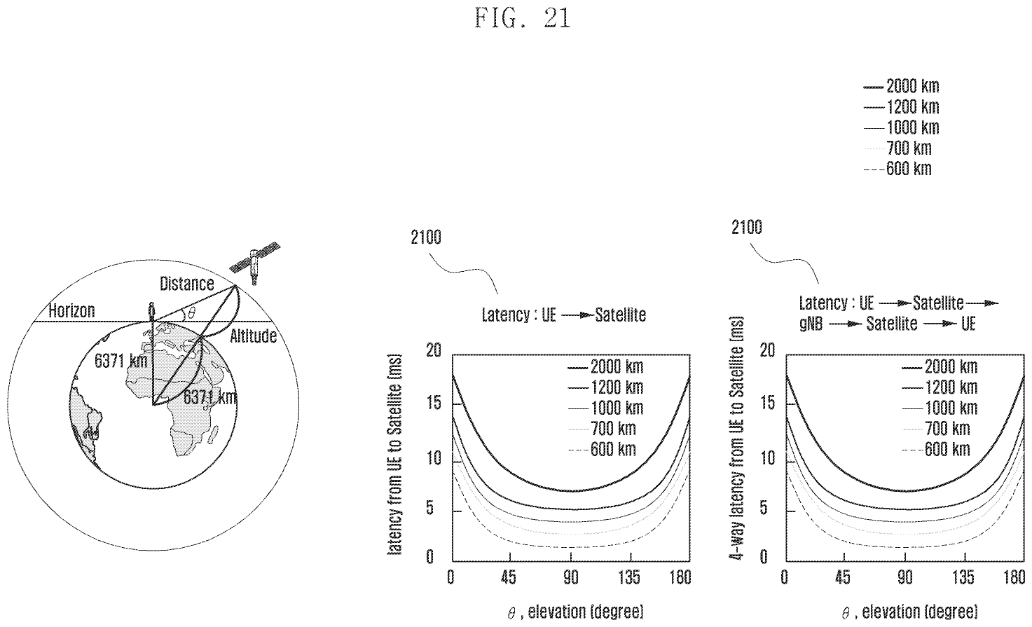

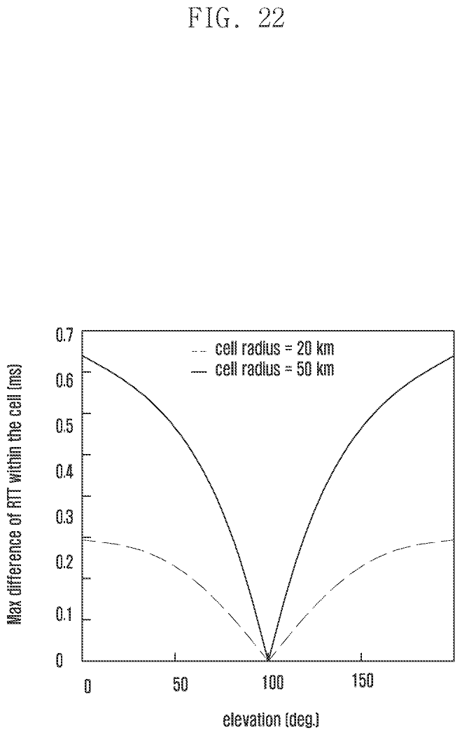

FIG. 21 illustrates a latency taken from a UE to a satellite and a round trip latency between a UE-a satellite-a base station according to the position of the satellite determined according to an elevation angle. Reference numeral 2100 indicates the latency from the UE to the satellite, and reference numeral 2110 indicates the round-trip latency between the UE-satellite-base station. Here, the latency between the satellite and the base station has been assumed to be equal to the latency between the UE and the satellite. FIG. 22 illustrates the value of maximum difference in round-trip latencies that vary according to a user's position within one beam. For example, when the beam radius (or cell radius) is 20 km, the difference in round-trip latencies to the satellite, which UEs in different positions within the beam experience differently depending on the position of the satellite, is about 0.28 ms or less.

The disclosure provides a method and apparatus in which, when a UE is a terminal capable of supporting both terrestrial communication and satellite communication, the UE operates differently depending on whether a signal transmission/reception situation occurs in terrestrial communication or occurs in satellite communication. To this end, a method and an apparatus for allowing the UE to first distinguish between terrestrial network communication and satellite communication are also provided.

### First Embodiment

The first embodiment provides a method and apparatus in which a terminal determines whether signal transmission and reception is performed using terrestrial network communication or using satellite communication during the signal transmission and reception.

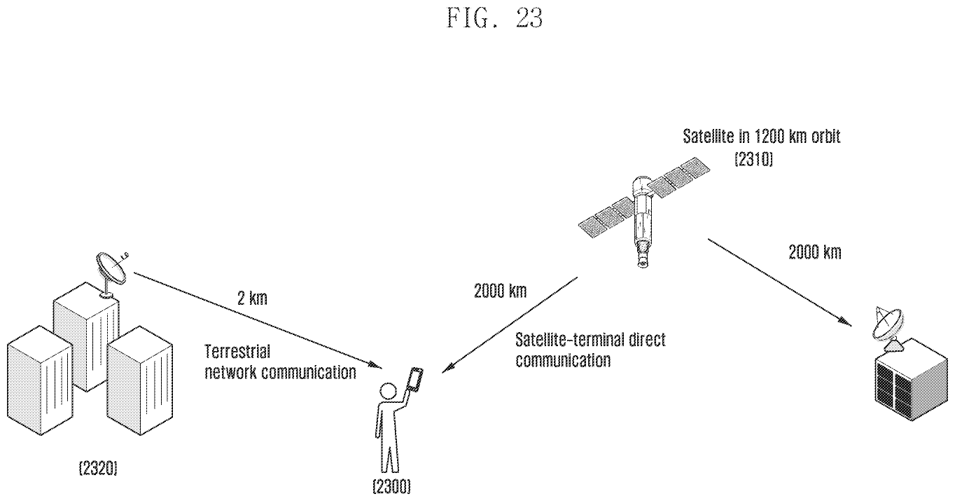

FIG. 23 illustrates an example in which one terminal may perform both a terrestrial network communication function and a satellite-terminal direct communication function. In the drawings, an example in which a corresponding terminal 2300 performs terrestrial network communication and satellite-terminal direct communication at the same time is illustrated, but in reality, only one of the two communications may be established. FIG. 23 shows an example in which the terminal 2300 is 2 km away from a base station 2320 and is 2000 km away from a satellite 2310 in terrestrial communication, and a distance from the base station or the satellite may vary depending on circumstances.

When a signal is received, the terminal may need to classify whether the corresponding signal is a signal transmitted from a satellite or a signal transmitted from a terrestrial base station. This may be needed for selecting a transmission antenna, a reception antenna, or a transmission/reception antenna, or may be needed for determining transmission power. For the above classification, the UE may use one of the following methods or a combination of one or more thereof. This method may be performed for distinguishing a transmission point in downlink. That is, the method may be performed for determining whether the transmission point corresponds to a terrestrial base station, whether the transmission point is for transmission to the terrestrial base station through a satellite, or whether the transmission point corresponds to a base station located on the satellite.
Method 1: A terminal may know in advance the location of a frequency band or region in which signals are transmitted and received through terrestrial communication and satellite communication. For example, this may correspond to a method in which frequency Band1 is a band allocated for terrestrial network communication, Band10 is allocated for satellite communication, and a terminal determines a transmission point based on a frequency band in which signals are transmitted and received. It is obvious that different frequency allocations may be considered for each country. That is, different frequency bands or the same frequency band may be allocated for each country for terrestrial communication and satellite communication.
Method 2: A terminal may determine a transmission point according to the terminal's location. For example, the terminal may try to access by knowing the terminal's location and the coverage of terrestrial network communication or satellite communication having been known in advance by the terminal itself, and selecting a method belonging to the coverage. In this method, the coverage of terrestrial network communication or satellite communication may refer to a geographical range in which terrestrial network communication or satellite communication may be performed.
Method 3: Different sequences of PSS or SSS or PSS and SSS (hereinafter referred to as PSS/SSS), transmitted from a terrestrial base station and a satellite, may be used, and the terminal may receive the PSS or SSS or PSS/SSS, and then determine whether the transmission point corresponds to a terrestrial base station, whether the transmission point is for transmission to the terrestrial base station through a satellite, or whether the transmission point corresponds to a base station located on the satellite.

Using different sequences as described above may be a combination of one or more of the methods in which: different types of sequences are used (e.g., in a case of a terrestrial base station, M-sequence is used as a PSS sequence and a gold sequence is used as an SSS sequence. However, a terrestrial base station may transmit SS through a satellite, or a satellite base station may use one or more of ZC sequence, M-sequence, or gold sequence for PSS and/or SSS); although the same type of sequence is used, the sequence carries different pieces of information depending on the transmission point (that is, a sequence is generated based on different pieces of information); or SS is transmitted through different time and/or frequency resources depending on the transmission point.

When access is performed based on the PSS and/or SSS, the terminal may determine whether a signal transmitted/received according to the PSS and/or SSS uses terrestrial network communication or uses satellite communication.
Method 4: A terminal may distinguish between terrestrial network communication and satellite communication by using spare 1 bit (or reserved 1 bit) which is included in the MIB and transmitted. The spare 1 bit may be information that the Release 15 NR terminal does not receive or interpret. Therefore, only a terminal supporting both terrestrial network communication and satellite communication interprets the spare 1 bit. Further, if the value of the spare bit is 0, the MIB may be interpreted as terrestrial network communication, and if the value of the spare bit is 1, the MIB may be interpreted as being transmitted using satellite communication, or vice versa.
Method 5: A specific bit or bits of SIB1 transmitted from the satellite have a fixed predetermined value, and when a terminal receives the SIB1, the terminal may find out that the SIB1 is transmitted using satellite communication based on the predetermined value.
Method 6: When a signal is transmitted/received using satellite communication, a specific SIB is transmitted from a satellite, and a terminal may receive the SIB so as to recognize that it is satellite communication or may interpret the bit field of the SIB so as to determine whether satellite communication is performed or not. In addition, for example, SIB 14 may include information on whether the transmission point is terrestrial communication or is related to satellite communication, and the SIB 14 may include detailed configuration parameter information related to terrestrial communication or satellite communication. Such SIB 14 is only an example, and other SIBs may include the above information.
Method 7: A terminal determines whether a transmission point or satellite communication is performed, based on a propagation delay required to transmit the signal from the transmission point. That is, if the propagation delay required for delivering a transmission signal from the transmission point is longer than a specific reference time (threshold), the terminal determines that it is a signal transmitted using satellite communication, and if the propagation delay required for delivering the transmission signal from the transmission point is shorter than a specific reference time (threshold), the terminal determines that it is a signal transmitted using terrestrial network communication.

For example, the propagation delay may be determined based on a difference between a reference time of a base station at which the base station transmits a signal and a reference time at which the terminal receives a signal from the base station. As an example, the base station may include, in the system information transmitted to terminals, global positioning system (GPS) reception time and/or location information of the base station itself (hereinafter, referred to as base station GPS time information, and GPS is only an example and this may be understood as information about time and location that the terminal and the base station can share. In addition, this may also be understood as information about time and/or location based on a specific system). In addition, the terminal may directly receive a separate GPS signal, and may configure its own reference time (terminal GPS time) by receiving the GPS signal.

Here, when a GPS system of the GPS time information, which is transmitted by the base station, and a terminal separately receive a GPS signal, the terminal may compare GPS time information (base station GPS time) transmitted by the base station and GPS time which is received and configured by the terminal itself (terminal GPS time), and may calculate a propagation delay from the satellite to the terminal or from the terminal to the satellite. In the disclosure, the GPS system is described as an example, but a global navigation satellite system (GNSS) other than GPS may be applied. In this case, the name or type of the GNSS system can be indicated by higher layer signaling. The base station may transmit information about the reference time to the terminal as system information or terminal-specific configuration information through higher layer signaling (ReferenceTimeInfo information element) as follows.

TABLE 21
ASN1START
TAG-REFERENCETIMEINFO-START
ReferenceTimeInfo-r16 ::= SEQUENCE {
time-r16 ReferenceTime-r16,
uncertainty-r16 INTEGER (0..32767) OPTIONAL, --NeedR
timeInfoType-r16 ENUMERATED {localClock} OPTIONAL, --
Need R
referenceSFN-r16 INTEGER (0..1023) OPTIONAL -- Cond
RefTime
}
ReferenceTime-r16 ::= SEQUENCE {
refDays-r16 INTEGER (0..72999),
refSeconds-r16 INTEGER (0..86399),
refMilliSeconds-r16 INTEGER (0..999),
refTenNanoSeconds-r16 INTEGER (0..99999)
}
TAG-REFERENCETIMEINFO-STOP
-- ASN1STOP

[ReferenceTimeInfo Field Descriptions]
referenceSFN: This field indicates the reference SFN corresponding to the reference time information. If referenceTimeInfo field is received in DLInformationTransfer message, this field indicates the SFN of PCell.
time: This field indicates time reference with 10 ns granularity. The indicated time is referenced at the network, i.e., without compensating for RF propagation delay. The indicated time in 10 ns unit from the origin is refDays*86400*1000*100000+refSeconds*1000*100000+refMilliSeconds*100000+refTenNanoSeconds. The refDays field specifies the sequential number of days (with day count starting at 0) from the origin of the time field.

If the referenceTimeInfo field is received in DLInformationTransfer message, the time field indicates the time at the ending boundary of the system frame indicated by referenceSFN. The UE considers this frame (indicated by referenceSFN) to be the frame which is nearest to the frame where the message is received (which can be either in the past or in the future).

If the referenceTimeInfo field is received in SIB9, the time field indicates the time at the SFN boundary at or immediately after the ending boundary of the SI-window in which SIB9 is transmitted.

If referenceTimeInfo field is received in SIB9, this field is excluded when determining changes in system information, i.e. changes of time should neither result in system information change notifications nor in a modification of valueTag in SIB 1.
timeInfoType: If timeInfoType is not included, the time indicates the GPS time and the origin of the time field is 00:00:00 on Gregorian calendar date 6 Jan. 1980 (start of GPS time). If timeInfoType is set to localClock, the origin of the time is unspecified.
uncertainty: This field indicates the uncertainty of the reference time information provided by the time field. The uncertainty is 25 ns multiplied by this field. If this field is absent, the uncertainty is unspecified.

That is, if the timeInfoType value is not configured or is not included, the time information may be a GPS-based time.
Method 8: Depending on a subscriber identification module (SIM) card used by a terminal to access the system, the terminal may distinguish whether a transmission point or satellite communication is performed. The terminal may use a SIM card to access the system, and depending on whether the SIM card is for terrestrial network communication or satellite communication, the terminal classifies signals transmitted and received by the terminal into signal for terrestrial network communication or signal for satellite communication.
Method 9: A terminal measures the strength (power or energy) of the received signal and determines whether it is terrestrial communication or satellite communication based on the strength. As an example, the terminal may identify a threshold value of the received signal strength that is predetermined or configured by the base station, and whether the received signal strength is a signal using terrestrial network communication or satellite communication depending on whether the received signal strength exceeds, or is equal to or less than the threshold value.
Method 10: A terminal estimates pathloss using the power of the transmitted signal and the strength of the received signal, and determines whether the received signal uses terrestrial network communication or satellite communication based on the value of path loss. This pathloss may be calculated based on the reception of the information on the transmission power and the strength of the received signal and the information on the received transmission power.

### Second Embodiment

The second embodiment provides a method and apparatus for selecting a transmission antenna according to whether a transmission signal is uplink transmission in terrestrial network communication or uplink communication in satellite communication in a situation in which a terminal transmits a signal. Hereinafter, a method for select a transmission antenna by a terminal will be described, but this may also be applied to a method for selecting a reception antenna by a terminal.

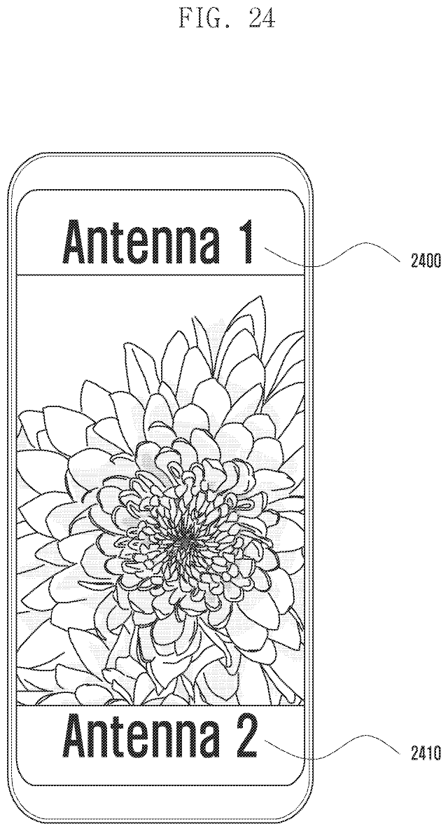

FIG. 24 illustrates the structure and location of a transmission/reception antenna of a terminal. The antennas may perform transmission and reception, respectively, but may be designed to perform only transmission or reception according to an operating method of the terminal. In a case of a terminal for terrestrial communication, a second antenna 2410 located at the lower part is used for transmission and reception, and a first antenna 2400 at the upper part in which a phone speaker is located is used only for reception in most cases. The reason may be that, when the first antenna 2400 is used as a transmission antenna, the effect of radio waves on the human body, especially on the head, is large. In terrestrial network communication, even if the second antenna 2410 located at the lower part of the terminal is used as the transmission antenna, the radio wave spreads horizontally and can be received by the base station, and thus there is no difference from the case in which the first antenna 2400 located at the upper part of the terminal is used as the transmission antenna.

On the other hand, in a case of satellite communication, since the satellite is located above the terminal, a method for performing transmission from an antenna located at the upper part of the terminal may experience less path loss or increase the antenna gain. Therefore, basically, by using a method for identifying whether satellite communication is being performed by the terminal provided in the first embodiment of the disclosure, in case that the satellite communication is identified being performed, when the terminal transmits a signal (by satellite), the first antenna 2400, which is an antenna at the upper part of the terminal, is used, and when the terminal transmits a signal using terrestrial network communication, the second antenna 2410, which is the lower part antenna of the terminal, may be used.

Meanwhile, a user may adjust the direction of a terminal in a random manner Therefore, when satellite communication is performed, an antenna used for transmission by the terminal may be an antenna at the upper part of the terminal, or may be an antenna which is close to the sky (or location of the satellite) by using a gyroscope sensor included in the terminal.

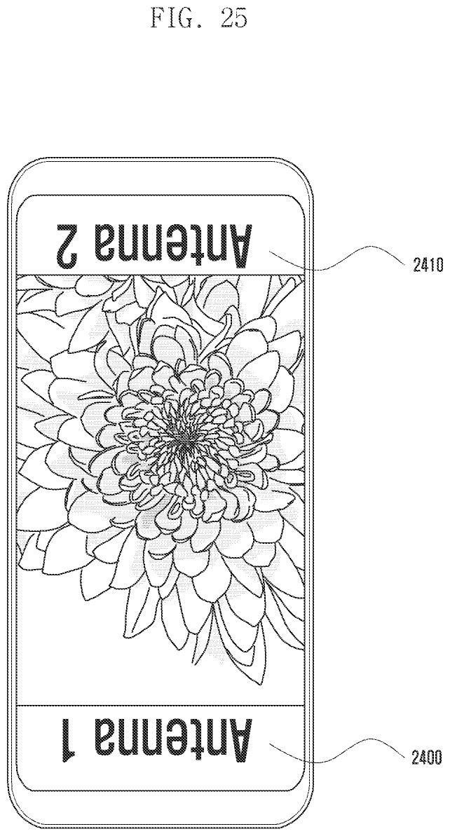

FIG. 25 illustrates an example in which a user adjusts the direction of a terminal in a random manner. For example, when the terminal is positioned upside down as shown in FIG. 25, the terminal may transmit a signal using the second antenna 2410 for satellite communication. When the terminal is turned over as shown in FIG. 25, the terminal may transmit a signal using the second antenna 2410 even for terrestrial communication.

A gyroscope sensor refers to a sensor capable of detecting the current direction of the terminal by using the rotational moment of inertia, which is a kind of inertial force, and may refer to a sensor capable of detecting x, y, z-axis direction and/or x, y, and z-axis acceleration of the terminal regardless of the detection method.

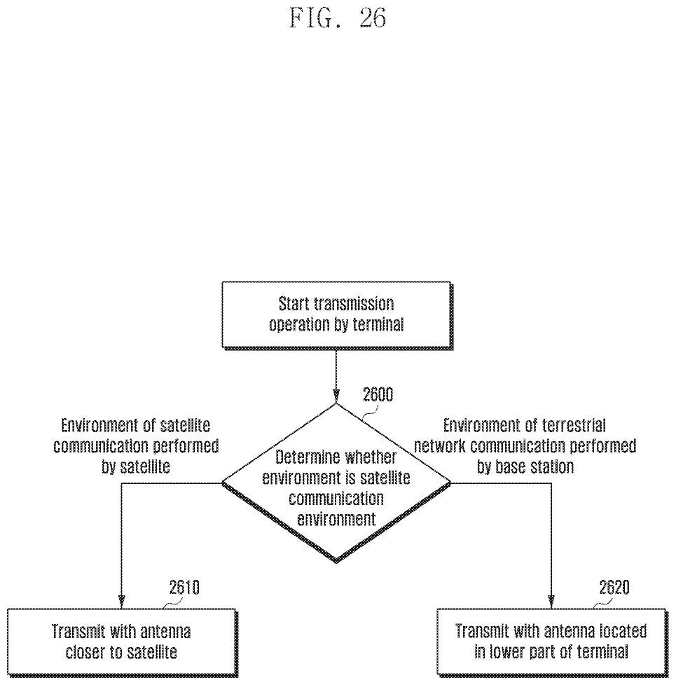

FIG. 26 illustrates a method in which a terminal determines an antenna to be used for communication. As shown in FIG. 26, that is, the method may include operation 2600 of determining, when the terminal selects an antenna used for signal transmission, whether it is a satellite communication environment, and the operation may be performed according to a combination of at least one of the methods described in the first embodiment. Based on the determination, the terminal may determine an antenna to be used for signal transmission. For example, when the terminal transmits a signal to a satellite, the terminal may transmit a signal using an antenna located closer to the satellite (indicated by reference numeral 2610), and when the terminal transmits a signal to a terrestrial base station, the terminal may transmit a signal using an antenna located at the lower part of the terminal (this may be fixed or different according to the direction of the terminal (indicated by reference numeral 2620).

### Third Embodiment

The third embodiment provides a method in which when a terminal supporting satellite network communication is connected to a base station through a satellite, the terminal displays the connection to the base station through a satellite to a user.

When the terminal accesses the base station through a satellite, the terminal may notify that it has accessed the satellite network by displaying an icon related to the satellite on the screen (or display) of the terminal. The terminal accessing the satellite network may be identified as meaning that the corresponding base station accesses the terminal and then delivers information indicating that access to the satellite network is established to the terminal. Alternatively, the terminal may determine that it has accessed the satellite network by the method provided in the first embodiment or the like.

In addition, when the UE accesses the satellite network, information related to the satellite network may be provided to the user. The information may include, for example, information related to a fee to be paid by a user when making a call using voice and/or video or a fee to be paid by the user when transmitting data. The information may be displayed when uploading or downloading data, or may be displayed at the moment the user presses a call button or a call starts.

### Fourth Embodiment

The fourth embodiment provides a method in which a terminal supporting terrestrial network communication and satellite network communication searches for a frequency in the process of finding a signal of a base station.

When the terminal supports a plurality of frequency bands, the terminal may select a frequency to be searched for first. Searching for a frequency in the above may be a process of finding a synchronization signal. In the frequency search process, the terminal may have information about a frequency band used for satellite network communication and a frequency band used for terrestrial network communication in advance. In this case, the terminal may first search for a frequency band used for terrestrial network communication. This is because, in general, the performance of terrestrial network communication can be better than that of satellite network communication.

As another example, the terminal may search for all frequency bands, and then may compare the strengths of signals transmitted by a satellite in a frequency band (e.g., the signal strength may be the strength of at least one synchronization signal or a reference signal transmitted by the satellite, and a signal to be to-be measured may be predetermined. This signal strength may be measured in units of dBm, and may be compared with a preconfigured or predetermined threshold value) so as to attempt access the base station first in a frequency band having a higher signal strength. Thereafter, when the attempted base station access is not successful, base station access in another frequency band may be attempted. When comparing the signal strengths, the terminal may compare the signal strength of a frequency band for satellite network communication with the sum of the signal strength of a frequency band for terrestrial communication and an offset value. In the above, a case in which the base station access is not successful may correspond to a case in which the terminal fails to receive a signal from the base station within a predetermined period of time in a random access procedure, or a case in which the terminal fails to receive a confirmation signal (e.g., msg 4) including the ID value of the terminal itself. For example, when the signal strength or signal-to-noise ratio of the frequency band for terrestrial network communication is “A”, and the signal strength or signal-to-noise ratio of the frequency band for satellite network communication is “B”, the terminal may directly compare A and B to select the frequency band of the terrestrial network or the satellite network and attempt access. However, as described above, when comparing “A+alpha” with “B” and “A+alpha” is greater than or equal to “B”, the terminal may attempt to access the base station in the terrestrial communication frequency band, and if “B” is larger than “A+alpha”, the terminal may attempt to access the base station in the frequency band for satellite network communication. This is because terrestrial network communication may generally have a small latency and may not have the Doppler effect compared to satellite network communication, stable communication can be expected, and thus it can be considered that the actual signal strength is greater.

The terminal attempts to access the base station in a selected band. For example, when the terminal selects a frequency band for terrestrial network communication according to the above-described method, the terminal acquires synchronization with the base station by receiving a synchronization signal or SSB, and then receives MIB and SIB to obtain configuration information, so as to perform a random access process. The terminal transmits the PRACH preamble to the base station using the terrestrial network, and receives the RAR from the base station. Thereafter, the terminal transmits Msg 3 based on a TA value and a UL grant, which are included in a received RAR, and receives Msg 4 from the base station.

For example, when the terminal selects a frequency band for satellite network communication, the terminal performs an operation similar to that when the terminal selects a frequency band for terrestrial network communication. In this case, after transmitting the PRACH preamble, the terminal may receive a configuration of the length of RAR window (this may be understood as a time at which the terminal attempts to detect DCI using RA-RNTI) having a value greater than 10 ms. This may be configured by system information, and the start timing of the RAR window may be a PDCCH region in which an RAR that appears first after PRACH preamble transmission can be transmitted.

Although the first to fourth embodiments of the disclosure have been separately described above for convenience of description, since each embodiment includes operations related to each other, it is also possible to combine at least two or more embodiments.

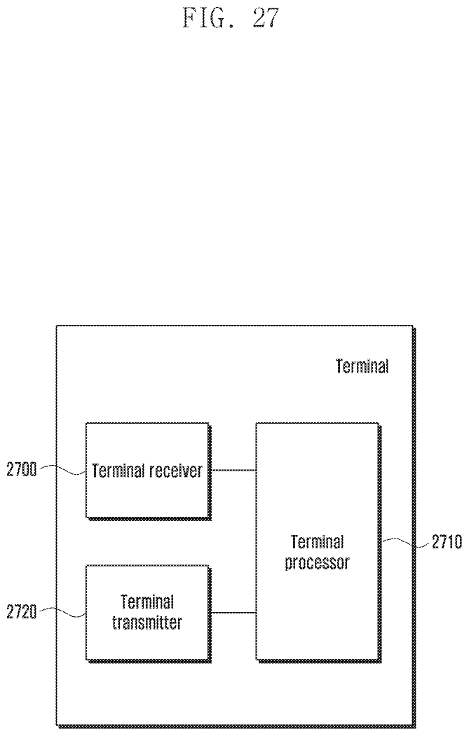

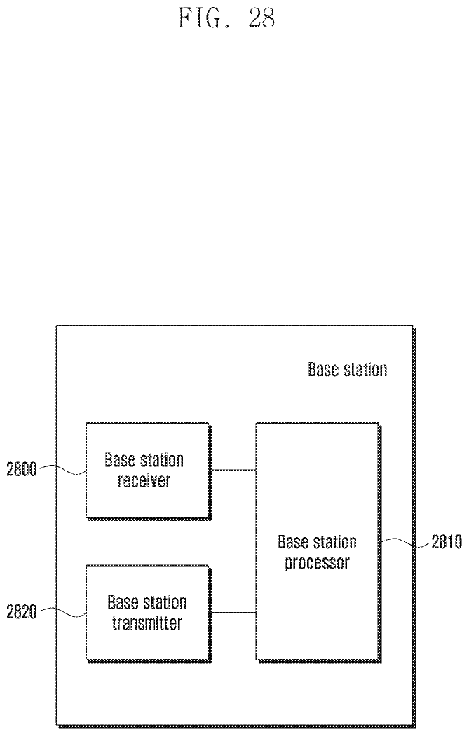

In order to perform the above embodiments of the disclosure, a transmitter, a receiver, and a processor of a terminal and a base station are shown in FIGS. 27 and 28, respectively. In order to perform an operation for determining signal transmission and reception from the first to fourth embodiments, a method for transmission and reception by a transmission terminal and a reception terminal in a base station and a terminal is shown. Further, in order to perform the method, a transmitter, a receiver, and a processor of the base station and the terminal need to operate according to the embodiment, respectively.

Specifically, FIG. 27 is a block diagram illustrating an internal structure of a terminal according to an embodiment of the disclosure. As shown in FIG. 27, the terminal of the disclosure may include a terminal receiver 2700, a terminal transmitter 2720, and a terminal processor 2710. The terminal receiver 2700 and the terminal transmitter 2720 may be collectively referred to as a transceiver in the embodiment of the disclosure. The transceiver may transmit/receive a signal to/from the base station. The signal may include control information and data. To this end, the transceiver may include an RF transmitter for up-converting and amplifying a frequency of a transmitted signal, and an RF receiver for low-noise amplifying a received signal and down-converting a frequency thereof. In addition, the transceiver may receive a signal through a radio channel and output the received signal to the terminal processor 2710, and may transmit a signal, which is output from the terminal processor 2710, through the radio channel. The terminal processor 2710 may control a series of processes so that the terminal can operate according to the above-described embodiment of the disclosure. For example, the terminal receiver 2700 may receive a signal from a satellite or a terrestrial base station, and the terminal processor 2710 may determine whether the received signal is received from a satellite or a terrestrial base station according to the method described in the disclosure, and may determine an antenna for transmission of a signal according to the determination. Thereafter, the terminal transmitter 2720 may transmit a signal by using the determined antenna. In addition, the terminal may include a sensor (e.g., a gyro sensor) for determining the direction of the terminal.

FIG. 28 is a block diagram illustrating an internal structure of a base station according to an embodiment of the disclosure. As shown in FIG. 28, the base station of the disclosure may include a base station receiver 2800, a base station transmitter 2820, and a base station processor 2810. The base station may be a terrestrial base station or part of a satellite. The base station receiver 2800 and the base station transmitter 2820 may be collectively referred to as a transceiver in the embodiment of the disclosure. The transceiver may transmit/receive a signal to/from the terminal. The signal may include control information and data. To this end, the transceiver may include an RF transmitter for up-converting and amplifying a frequency of a transmitted signal, and an RF receiver for low-noise amplifying a received signal and down-converting a frequency thereof. In addition, the transceiver may receive a signal through a radio channel and output the received signal to the base station processor 2810, and may transmit a signal, which is output from the base station processor 2810, through the radio channel. The base station processor 2810 may control a series of processes so that the base station can operate according to the above-described embodiment of the disclosure. For example, the base station processor 2810 may transmit a signal to the terminal if necessary according to configuration information configured by the base station processor itself. For example, the base station may transmit different signals to the terminal depending on whether the base station is a terrestrial base station or a satellite.

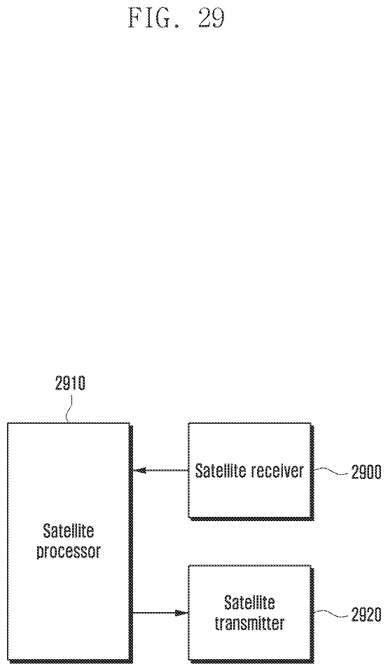

FIG. 29 is a block diagram illustrating an internal structure of a satellite according to an embodiment of the disclosure. As shown in FIG. 29, the satellite of the disclosure may include a satellite receiver 2900, a satellite transmitter 2920, and a satellite processor 2910. In the above, the receiver, the transmitter, and the processor are shown in a singular number, but may be configured by a plurality of units. For example, the satellite receiver 2900 and the satellite transmitter 2920 may include a receiver and a transmitter for transmitting/receiving signals to/from a terminal, and a receiver and a transmitter for transmitting and receiving signals with the base station, respectively. The satellite receiver 2900 and the satellite transmitter 2920 may be collectively referred to as a satellite transceiver in an embodiment of the disclosure. The transceiver may transmit/receive signals to/from the terminal and the base station. The signal may include control information and data. To this end, the transceiver may include an RF transmitter for up-converting and amplifying a frequency of a transmitted signal, and an RF receiver for low-noise amplifying a received signal and down-converting a frequency thereof. In addition, the transceiver may receive a signal through a radio channel and output the received signal to the satellite processor 2910, and may transmit a signal, which is output from the satellite processor 2910, through the radio channel. The satellite processor 2910 may include a compensator (pre-compensator) for correcting a frequency offset or a Doppler shift, and may include a device for tracking the position of a satellite using a system such as GPS. In addition, the satellite processor 2910 may include a frequency shift function capable of shifting the center frequency of the received signal. The satellite processor 2910 may control a series of processes so that the satellite, the base station, and the terminal can operate according to the above-described embodiment of the disclosure. For example, the satellite receiver 2900 may determine to transmit the information to the base station while receiving a PRACH preamble from the terminal and transmitting an RAR according thereto to the terminal again. Thereafter, the satellite transmitter 2920 may transmit the corresponding signals at the determined timing.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. Further, other variants of the above embodiments, based on the technical idea of the embodiments, may be implemented in LTE, 5G, and other systems.

1.-14. (canceled)

15. A method performed by a terminal in a communication system, the method comprising:
receiving signals using a frequency band; and
identifying whether the signals are received using a non-terrestrial network (NTN) based on the frequency band,
wherein in case that the frequency band is for the NTN, the signals are received using the NTN.

16. The method of claim 15, further comprising:
receiving system information block (SIB) for the NTN; and
identifying that the NTN-based communication is performed in case that the SIB for the NTN is received.

17. The method of claim 16,
wherein the SIB for the NTN includes time information associated with a satellite providing service to the terminal, and
wherein the time information indicates a time in multiples of a specific time unit after a reference point.

18. The method of claim 16, wherein the SIB for the NTN includes location information of a satellite providing service to the terminal.

19. The method of claim 16, wherein the SIB for the NTN includes information for random access response (RAR) window to receive a RAR message.

20. A method performed by a node supporting a non-terrestrial network (NTN) in a communication system, the method comprising:
identifying whether to transmit signals using NTN; and
in case that the signals are to be transmitted using the NTN, transmitting the signals using a frequency band for the NTN.

21. The method of claim 20, further comprising:
transmitting system information block (SIB) for the NTN; and
identifying that the NTN-based communication is performed in case that the SIB for the NTN is received.

22. The method of claim 21,
wherein the SIB for the NTN includes time information associated with a satellite providing service to a terminal, and
wherein the time information indicates a time in multiples of a specific time unit after a reference point.

23. The method of claim 21, wherein the SIB for the NTN includes location information of a satellite providing service to a terminal.

24. The method of claim 21, wherein the SIB for the NTN includes information for random access response (RAR) window to transmit a RAR message.

25. A terminal in a communication system, the terminal comprising:
a transceiver; and
a controller coupled with the transceiver and configured to:
receive signals using a frequency band, and
identify whether the signals are received using a non-terrestrial network (NTN) based on the frequency band,
wherein in case that the frequency band is for the NTN, the signals are received using the NTN.

26. The terminal of claim 25, wherein the controller is further configured to:
receive system information block (SIB) for the NTN, and
identify that the NTN-based communication is performed in case that the SIB for the NTN is received.

27. The terminal of claim 26,
wherein the SIB for the NTN includes time information associated with a satellite providing service to the terminal,
wherein the time information indicates a time in multiples of a specific time unit after a reference point.

28. The terminal of claim 26, wherein the SIB for the NTN includes location information of a satellite providing service to the terminal.

29. The terminal of claim 26, wherein the SIB for the NTN includes information for random access response (RAR) window to receive a RAR message.

30. A node supporting a non-terrestrial network (NTN) in a communication system, the node comprising:
a transceiver; and
a controller coupled with the transceiver and configured to:
identify whether to transmit signals using NTN, and
in case that the signals are to be transmitted using the NTN, transmit the signals using a frequency band for the NTN.

31. The node of claim 30, wherein the controller is further configured to:
transmit system information block (SIB) for the NTN, and
identify that the NTN-based communication is performed in case that the SIB for the NTN is received.

32. The node of claim 31,
wherein the SIB for the NTN includes time information associated with a satellite providing service to a terminal, and
wherein the time information indicates a time in multiples of a specific time unit after a reference point.

33. The node of claim 32, wherein the SIB for the NTN includes location information of a satellite providing service to the terminal.

34. The node of claim 32, wherein the SIB for the NTN includes information for random access response (RAR) window to transmit a RAR message.
